(19) United States
(12) Patent Application Publication
(10) Pub. No.: US 2016/0231579 A1
(43) Pub. Date: Aug. 11, 2016

(54) AUTOSTEREOSCOPIC PRISMATIC PRINTING RASTERS

(71) Applicant: IQ STRUCTURES S.R.O., Husinec-Rez (CZ)

(72) Inventor: Gennadij Borovkov, Minsk (BY)

(21) Appl. No.: 15/019,149

(22) PCT Filed: Aug. 8, 2014
(86) PCT No.: PCT/EP2014/067128

§ 371 Date: Feb. 9, 2016

(30) Foreign Application Priority Data
Aug. 9, 2013 (GB) 1314264.1

(51) Int. Cl. G02B 27/22; B41M 3/06; H04N 13/04

(52) U.S. Cl. CPC G02B 27/2242; G02B 27/2214; G02B 27/225; H04N 13/0443; H04N 13/0415; B41M 3/06

(57) ABSTRACT

An autostereoscopic prismatic raster for the creation of a stereoscopic image from an array of interlaced stripes of lef- and right-images of a stereo pair, wherein the distance between adjacent stripes within each interlaced stereo image defines a stereo image period, said stereo image period being substantially equal to a raster period, the raster comprising: (i) a body of optically isotropic material having a first side comprising a substantially planar face through which the stereoscopic image is viewable by an observer, and a second side comprising an array of a plurality of relief optical elements adjacent one another and preferably without gaps between adjacent ones thereof; (ii) each said relief optical element having a relief surface and a polygonal cross-section comprising at least one triangular cross-section with left and right side portions and a base with a length corresponding to said raster period; wherein: (iii) for creating said stereoscopic image, a total internal reflection occurs on the relief surface of each relief optical element and boundary limit light rays of total internal reflection pass through the substianally planar face of the first side of the raster body; and (iv) for viewing said stereoscopic image due to the effect of total internal reflection, the left parts of the stereoscopic image pass through the left side portions of relief optical elements within each raster period and are directed substantially towards the observer's left eye, and the right parts of the stereoscopic image pass through the right side portions of relief optical elements within each raster period and are directed substantially towards the observer's right eye. The rasters may be mono-layer or dual-layer. In some forms each prism element has a cross-section in the form of an isosceles triangle having a base and adjacent left and right sides. In other forms each prism element is in the form of a bidirectional Fresne130 microprism having a base defining a raster period and comprising a plurality of microprismatic elements, e.g. of micron or sub-micron size, each having a cross-section in the form of a right triangle. The output layer of such rasters has the greatest refractive index, which ensures the total internal reflections on the prism relief surfaces direct the light from the interlaced stereo images to the observer's respective left and right eyes. The rasters can be affixed to a wide variety of surfaces and products, with virtually any curvature.

### FIELD OF THE INVENTION

This invention relates to autostereoscopic prismatic rasters, especially for use in printing. More particularly it relates to autostereoscopic prismatic and microprismatic optical raster elements, especially of micron and sub-micron sizes, which utilise the effect of total internal reflection for the realisation of the principle of divided vision, especially during printing and viewing of stereo images.

The invention further relates to methods for the manufacture of autostereoscopic prismatic and microprismatic printing rasters, which may for example be of mono-layer or dual-layer species. The invention still further relates to methods for the printing of constructions and products comprising said rasters, as well as to such constructions and products so produced.

The invention is applicable to various fields particularly in relation to printing, such as printing of books, booklets, brochures, postcards, stamps, calendars, promotional items, advertising and display materials, photographs, packaging, labels, security elements and security documents, and various other types of documents.

### BACKGROUND OF THE INVENTION AND PRIOR ART

In the following description citation will be made to various existing literature references, whose disclosures are all incorporated herein by reference, by numbering in square parentheses referring to the listed bibliography hereinbelow.

Nature granted people two eyes and therefore an ability to see the surrounding world in three dimensions by means of binocular vision. As illustrated in FIG. 1a of the accompanying drawings, human eyes are set apart a certain distance, with the result that a given real point object at different locations 1 and 2, or separated points 1 and 2 of a real object, are seen by the left and right eyes at different angles α₁ and α₂, respectively. This means that left and right images of objects or points 1 and 2 are slightly different, so based on analysis by the brain people can perceive information about real distances to the objects or points 1 and 2 and their relative positions.

As described in [1], as early as 280 B.C. Euclid discovered these differences in images of the same object for the left and right eyes. Around the year 1600, some 200 years before the invention of photography, the Italian scientist Giovanni Battista della Porta tried to create the first 3D images by making thorough drawings of what are now called side-by-side stereo pairs [2]. In this respect, the centres of the left and right parts of the stereo pair, when viewed directly, were set apart at a distance equal to the average distance between human pupils. In 1838 Sir Charles Wheatstone demonstrated the first reflecting stereoscope which facilitated viewing of stereo images, and in 1849 Sir David Brewster invented a prismatic stereoscope. This latter discovery may thus be considered as the date when prisms were used in stereoscopy for the first time.

The ability of three-dimensional space perception with two eyes is called stereoscopic vision, and the divided vision of a “left” image by the left eye only and a “right” image by the right eye only is the principal condition for volumetric 3D vision. These two images are called a stereo pair.

The divided vision principle is the main principle for creation of simulated stereo effects in the printing industry.

This principle may be understood quite easily. As shown in FIG. 1b of the accompanying drawings, consider a O-O plane, which is called a projection plane (or a screen plane at a stage of image recreation), passing between the point objects 1 and 2 and parallel to the observer's face. /

Considcring object 1 first, outgoing light rays from Object 1 located behind the O-O plane will then cross this O-O plane at points 1R and 1L (stereo pair points), and if these points 1R and 1L are marked by either a printed or an electronic pixel, the observer will be able to obtain information about the spatial position of object 1 relative to the O-O plane and therefore to the eyes of the observer. During this process, however, it is necessary that light from the right and the left image points 1R, 1L on the projection plane O-O should reach only the right or the left eye, respectively, of the observer. As further illustrated in FIG. 1b, the position of object 2 located in front of the O-O plane may be recorded in the same way, and information about its spatial position can be obtained via its corresponding 2R and 2L stereo pair points.

However, if some object is placed actually in the O-O projection plane, both eyes of the observer see the same left and right images, which are formed either by the actual point object or by its point image.

There are two known methods for achieving divided vision: with or without glasses.

In the case of glasses as a means of achieving divided vision, there are three types of methodology that may be employed: anaglyph, polarising or eclipse.

The essence of the anaglyph method is the painting of a stereo pair with additional colours and using colour filter glasses which permit passage therethrough of one only of either the left- or right-painted images, thereby separating the images as dictated by their colour. This method was invented more than 150 years ago and applied in cinematography by Louis Lumière in 1935.

The polarising method was developed about 120 years ago and became widely known after the invention of polarising film by E. Land in 1935. Left and right images are projected onto a screen simultaneously as in the anaglyph method, but light for the different images is polarised linearly or circularly in orthogonal directions. Corresponding polarisation of a film on one lens of the glasses allows light for one image only to pass therethrough, and stops the light from the other image, and vice versa for the other lens whose film is polarised oppositely.

The eclipse method appeared relatively recently, and is realised using special glasses in which normal glass is substituted with rapidly-switchable liquid-crystal (LCD) valves selecting differently polarised light. The valves are synchronised with the projected image display, so if a left image is displayed momentarily the left lens of the glasses transmits light and the right lens does not, and vice versa when a right image is displayed.

All three methods have two major disadvantages: one is the necessity to use glasses themselves, and the other is the forming of stereo images by reference to two angles only.

In contrast, glassless—or autostereoscopic—methods are predicated on the fact that there is no need to use any additional equipment between formed images and an observer's eyes as a means of dividing left and right images. Known such methods include raster and dynamical autostereoscopic methods.

Considering the dynamical method first of all, the first practical realisation of this method was the use of electron ray deflection in a magnetic field with simultaneous usage of a lenticular screen for multi-zone autostereoscopic image display [3].

Dynamical autostereoscopy methods received a boost in recent years because of improvements in hardware components and materials whose optical and mechanical properties are sensitive to the electric field exposure [4, 5]. Being exposed to the electrical field, such materials are able to change the degree of emitted pixel beam collimation and deflect the collimated beam in a direction required by the observer who should be able to see a volumetric 3D image. Advantages of these known dynamical methods include the unrestricted position of viewer in relation to the display, high brightness and high resolution. However, disadvantages of these known methods include complicated component manufacturing processes and narrow material choice restrictions.

Considering the raster methods, the following known raster methods are routinely used for creating stereoscopic images: slit (which is based on the parallax barrier effect) and lensed (or lenticular) rasters.

Rasters consisting of transparent and non-transparent vertical narrow stripes as selecting elements for providing the divided vision by left and right eyes were proposed for the first time as long ago as 1903 [6]. Since some upgrading in the 1930's, the parallax barrier raster creation principle has remained unchanged and is widely used [7] in the field of 3D displays. It is illustrated in FIG. 2 of the accompanying drawings.

To create stereo images some preliminary preparation is required: Two flat images which are a stereo pair of a volumetric 3D image are cut into narrow stripes, interlaced and reproduced as vertical columns of a display. The received images are called interlaced images, and the distance between adjacent left and right image pixels defines a halftone period from which a 3D image is formed. Nowadays lenticular screens with a frequency of 60 lpi, 75 lpi or 100 lpi are used in the printing industry. It should be noted that left and right side-by-side stereo pair images can be viewed as two adjacent bands of some macro-interlaced image.

Parallax barrier rasters are normally placed between the observer and the display with emitting pixels. A light beam from every second pixel passes through the respective transparent stripes to one eye of the observer only, and the non-transparent stripes stop it on the way to the observer's other eye.

The present inventor was interested in considering opportunities for using parallax barrier rasters in printing applications primarily because of the necessity for creating stereo images of a small thickness.

To achieve this purpose, and as illustrated in FIG. 2, the calculation of the period b of the raster slits and the raster slit position in relation to the interlaced images' pixels may be performed as described in [8]. For viewing 3D images, the pixels and raster slits should be coordinated with a central point P between the observer's eyes e (A being the right-hand limit of the right eye and B being the left-hand limit of the left eye) for the pixel angular size to be equal to the angular size of the slit. This condition is satisfied if:

(b/2)/i=(z−g)/z (1)

where i is the interlaced image pixel size,

z is the distance from the pixel plane to the observer,

g is the distance between pixel planes and the parallax raster barrier, and

b is the parallax barrier raster period.

From the similarity of ABC and CDE one further equation is satisfied:

i/g=2e/(z−g) (2)

where e is the distance between the observer's eyes.

Solving the simultaneous equations (1) and (2) in relation to b and g leads to the following equations being deduced:

b=4 ie/(2e+i) (3)

g=iz/(2e+i) (4)

Thus, for typical values of printed images viewing: z=30 cm, e=6.5 cm, i=50 μm (=0.005 cm), the parallax barrier raster plane with period b ˜100μm should be positioned at a distance g ˜115 μm from the pixel plane.

Unfortunately, in addition to the relatively large thickness of parallax barrier rasters, they have other disadvantages, namely:

1. An aesthetic appearance resembling “Black Square” by Malevich is unacceptable for many printing products;

2. Insufficient brightness caused by the use of non-transparent stripes;

3. Insufficient image sharpness caused by diffraction at the slit edges;

4. Diffractional noise caused by optical diffraction at the periodic structure of the raster, such as at an amplitude diffraction grating with a 100 μm period;

5. Crosstalk levels are up to 5% [9];

6. Two-fold decrease of image resolution in comparison with the original image.

In summary, it is impossible to obtain satisfactory thin printed stereo images based on known parallax barrier rasters. Nevertheless, they have found widespread use in other applications such as 3D television.

Looking further at the history of autostereoscopic rasters, the application of lensed optical elements in autostereoscopic rasters dates from 1908, when G. Lippmann [10] proposed to use spherical lenses as an optical stereo raster element. Since the 1930's cylindrical lenses have appeared, and after some period of improvement in their manufacturing process, such rasters eventually attained widespread use in postcards and other merchandise items.

Their operating principle is shown in FIG. 3 of the accompanying drawings. Similarly to the parallax barrier calculation [8] and taking into account the geometrical features of lensed rasters, the initial system of two equations is as follows:

l/2i=(z−f)/z (5)

i/f=e/(z−f) (6)

where i is the interlaced image pixel size,

z is the distance between the pixel plane and the observer,

f is the distance between the pixel plane and the lenticular raster, and

l is the size of each lenticular raster lens.

Solving the simultaneous equations (5) and (6) in relation to l and f leads to the following equations being deduced:

l=2 i e/(e+i) (7)

f=i z/(e+i) (8)

Thus, for typical values of printed images viewing: z=30 cm, e=6.5 cm, i=50 μm (=0.005 cm), the lenticular raster plane with size of lenses l ˜100 μm should be positioned at a distance f ˜231 μm from the pixel plane.

Comparison of equations (4) and (8) shows that the lenticular raster must therefore be located—two times further away from the pixel plane than is the case with the parallax barrier raster.

Advantages of lenticular rasters include a high brightness of 3D images and acceptable aesthetic appearance. Unfortunately, however, lenticular rasters also suffer from various disadvantages, namely:

1. Large raster thickness;

2. Small (minimum 16 μm [11]) thicknesses cause significant aberrations;

3. Crosstalk levels are up to 20% [9];

4. Opened lens relief;

5. Small angle of 3D image spanning;

6. Flipping effect, leading to an unpleasant hopping of the 3D image in cases where the viewing angle changes;

7. Two-fold decrease of image resolution in comparison with the original image.

Advances in home cinema theatres have led to the development of the idea of prismatic reflecting 3D screens, which were proposed originally by P. P. Sokolov back in 1911 [12]. More recently, in references [13] and [14], reflecting 3D screens with micro-prisms scaled to 100 μm with oblique triangular [13] or rectangular [14] profiles were proposed. Also, substantially zero crosstalk levels were able to be achieved. Unfortunately, however, it is impossible to apply reflecting prisms in the printing industry.

Transparent micro-prisms were initially proposed for 3D display manufacturing in U.S. Pat. No. 5,774,262 [16], with an optical element profile in which one half is biprismatic and deflects a light beam to one eye of the observer and the other half is flat and transmits light to the other eye. At the same time the distance between the raster and the display plane was quite significant.

In other US Patents U.S. Pat. No. 6,791,570 [17] and U.S. Pat. No. 6,659,615 [18] such a display construction was upgraded by means of collimated light and a focusing optical element. This model was named “D4D” but the system proposed there could not be applied in printing products because of construction complexity and significant thickness.

There therefore exists in the art to date a significant need for autostereoscopic printing rasters that ameliorate, or preferably even solve, at least some, or preferably many or even substantially all, of the above problems associated with known autostereoscopic rasters. It is a primary object of the present invention to meet this need.

### SUMMARY OF THE INVENTION

In its broadest defined form, the present invention provides, in a first aspect, an autostereoscopic prismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a raster period, the raster comprising:
(i) a body of optically isotropic material having a first side comprising a substantially planar face through which the stereoscopic image is viewable by an observer, and a second side comprising an array of a plurality of relief optical elements adjacent one another;
(ii) each said relief optical element having a relief surface and a polygonal cross-section comprising at least one triangular cross-section with left and right side portions and a base with a length corresponding to said raster period;
wherein:
(iii) for creating said stereoscopic image, a total internal reflection occurs on the relief surface of each relief optical element and boundary limit light rays of total internal reflection pass through the substantially planar face of the first side of the raster body; and
(iv) for viewing said stereoscopic image due to the effect of total internal reflection, the left parts of the stereoscopic image pass through the left side portions of relief optical elements within each raster period and are directed substantially towards the observer's left eye, and the right parts of the stereoscopic image pass through the right side portions of relief optical elements within each raster period and are directed substantially towards the observer's right eye.

In preferred embodiments of the invention preferably each prism element of the array has a triangular cross-section.

In embodiments of the invention the triangular cross-section may be either in the form of an oblique, cspccially an isosueles, triangle, or a right triangle (i.e. a right-angled triangle).

Preferably the individual prism elements forming the array on the second side of the raster body are configured adjacent one another, preferably contacting one another without gaps, especially without substantial gaps, in between adjacent prism elements.

Preferably the optically isotropic material forming the body of the raster has a refractive index nₒ. Preferably, in use for viewing the stereoscopic image, the first and second sides of the raster body are in contact with a medium with a refractive index lower than nₒ, which medium is preferably air.

Prismatic rasters according to the first aspect of the invention may take various forms, and include species which may be defined as either prismatic rasters or bidirectional (or otherwise called Fresnel-type) microprismatic rasters. Furthermore, either species of raster may be designated a “mono-layer” raster or a “dual-layer” raster, depending on the number of optical layers making up the main body of the raster and on or between which (as the case may be) the array of prism elements is provided. It is however to be understood that such species' definitions do not preclude the optional presence, for various purposes as will be discussed hereinbelow, of at least one additional layer in each respective raster construction in addition to the main optical single or dual raster body layers (as the case may be) on or between which (as the case may be) the array of prism elements is provided. Thus:

In accordance with a first embodiment of this first aspect of the invention, there is provided a mono-layer prismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period, the prismatic raster comprising:
(i) a body of optically isotropic material having a first side comprising a substantially planar face through which the stereoscopic image is viewable by an observer, and a second side comprising an array of a plurality of prism elements adjacent one another and preferably substantially without gaps in between adjacent prism elements;
(ii) each said prism element having a relief surface and a cross-section in the form of an isosceles triangle with left and right sides and a base having a length corresponding to said prismatic raster period;
wherein.
(iii) for creating said stereoscopic image, a total internal reflection occurs on the relief surface of each prism element and boundary limit light rays of total internal reflection pass through the substantially planar face of the first side of the raster body; and
(iv) for viewing said stereoscopic image due to the effect of total internal reflection, the left parts of the stereoscopic image pass through the left sides of said prism elements within each raster period and are directed substantially towards the observer's left eye and the right parts of the stereoscopic image pass through the right sides of said prism elements within each raster period and are directed substantially towards the observer's right eye.

In accordance with a second embodiment of this first aspect of the invention, there is provided a mono-layer microprismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period, the microprismatic raster comprising:
(i) a body of optically isotropic material having a first side comprising a substantially planar face through which the stereoscopic image is viewable by an observer, and a second side comprising an array of a plurality of identical microprism elements adjacent one another and preferably substantially without gaps in between adjacent microprism elements, each said microprism element having left and right portions;
(ii) each of said left portions of each microprism element having a cross-section in the form of an array of left-directional Fresnel microprisms and each of said right portions of each microprism element having a cross-section in the form of an array of right-directional Fresnel microprisms, each said Fresnel microprism having a relief surface and a cross-section in the form of a right triangle, wherein in a left half of each prismatic period the Fresnel microprisms each have a left-directed hypotenuse and a first base, and in a right half of each prismatic raster period the Fresnel microprisms each have a right-directed hypotenuse and a second base, the said first and second bases of the Fresnel microprisms being parallel to a base of the respective microprism element, and within each prismatic raster period a sum of the lengths of the first and second bases of the left-directional and the right-directional Fresnel microprisms corresponds to said prismatic raster period;
wherein:
(iii) for creating said stereoscopic image, a total internal reflection occurs on the relief surfaces of the Fresnel microprisms of each of the microprism elements and boundary limit light rays of total internal reflection pass through the substantially planar face of the first side of the raster body; and
(iv) for viewing said stereoscopic image due to the effect of total internal reflection, the left parts of the stereoscopic image pass through said left-directional Fresnel microprism elements within the left half of each prismatic raster period and are directed substantially towards the observer's left eye, and the right parts of the stereoscopic image pass through said right-directional Fresnel microprism elements within the right half of each prismatic raster period and are directed substantially towards the observer's right eye.

In accordance with a third embodiment of this first aspect of the invention, there is provided a dual-layer prismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period, the prismatic raster comprising:
(i) a body comprising a first layer of optically isotropic material with refractive index nₒ, and a second layer of optically isotropic material with refractive index nᵢ, with the proviso that nₒ>nᵢ,
wherein the first and second layers each include an outer side and an inner side, the outer side of the first layer comprising a substantially planar face through which the stereoscopic image is viewable by an observer,
and wherein the inner sides of the first and second layers each comprise an array of a plurality of prism elements adjacent one another and preferably substantially without gaps in between adjacent prism elements, the array of prism elements on the inner side of the first layer contacting the array of prism elements on the inner side of the second layer;
(ii) each said prism element on the inner side of each of the first and second layers having a relief surface and a cross-section in the form of an isosceles triangle having a base and adjacent left and right sides, the length of said base of each isosceles triangle corresponding to said prismatic raster period,
wherein an isosceles triangular prism element of one of the first or second layers together with a complementary pair of contacting isosceles triangular prism elements of the other of the first or second layers located to either side of the said first-mentioned isosceles triangular prism element constitute a prismatic unit having a cross-section in the form of a rectangle, the length of said rectangle corresponding to said prismatic raster period;
wherein:
(iii) for creating said stereoscopic image, a total internal reflection occurs on the relief surface of each prism element and boundary limit light rays of total internal reflection pass through the substantially planar face of the first side of the raster body; and
(iv) for viewing said stereoscopic image due to the effect of total internal reflection, the left parts of the stereoscopic image pass through the left sides of said prism elements in the first layer within each raster period and are directed substantially towards the observer's left eye and the right parts of the stereoscopic image pass through the right sides of said prism elements in the first layer within each raster period and are directed substantially towards the observer's right eye.

In accordance with a fourth embodiment of this first aspect of the invention, there is provided a dual-layer microprismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period, the microprismatic raster comprising:
(i) a body comprising a first layer of optically isotropic material with refractive index nₒ, and a second layer of optically isotropic material with refractive index nᵢ, with the proviso that nₒ>nᵢ,
wherein the first and second layers each include an outer side and an inner side, the outer side of the first layer comprising a substantially planar face through which the autostereoscopic image is viewable by an observer,
and wherein the inner sides of the first and second layers each comprise an array of a plurality of identical microprism elements adjacent one another and preferably substantially without gaps in between adjacent microprism elements, each said microprism element having left and right portions, the array of microprism elements on the inner side of the first layer contacting the array of microprism elements on the inner side of the second layer;
(ii) each of said left portions of each microprism element having a cross-section in the form of an array of left-directional Fresnel microprisms and each of said right portions of each microprism element having a cross-section in the form of an array of right-directional Fresnel microprisms, each said Fresnel microprism having a relief surface and a cross-section in the form of a right triangle,
wherein in a left half of each prismatic period the Fresnel microprisms each have a left-directed hypotenuse and a first base, and in a right half of each prismatic raster period the Fresnel microprisms each have a right-directed hypotenuse and a second base, the said first and second bases of the Fresnel microprisms being parallel to a base of the respective microprism element, and within each prismatic raster period a sum of the lengths of the first and second bases of the left-directional and the right-directional Fresnel microprisms corresponds to said prismatic raster period,
and wherein a Fresnel microprism of one of the first or second layers together with a complementary pair of contacting Fresnel microprisms of the other of the first or second layers located to either side of the said first-mentioned Fresnel microprism constitute a Fresnel microprismatic unit having a cross-section in the form of a rectangle, a sum of the lengths of said Fresnel microprismatic units corresponding to said prismatic raster period;
wherein:
(iii) for creating said stereoscopic image, a total internal reflection occurs on the relief surfaces of the Fresnel microprisms of each of the microprism elements and boundary limit light rays of total internal reflection pass through the substantially planar face of the first side of the raster body; and
(iv) for viewing said stereoscopic image due to the effect of total internal reflection, the left parts of the stereoscopic image pass through said left-directional Fresnel microprism elements in the first layer within the left half of each prismatic raster period and are directed substantially towards the observer's left eye, and the right parts of the stereoscopic image pass through said right-directional Fresnel microprism elements in the first layer within the right half of each prismatic raster period and are directed substantially towards the observer's right eye.

In some examples of rasters according to the first or third embodiments, the angles adjacent the base of each isosceles triangle of each prism element may be substantially equal to a critical angle of total internal reflection at a boundary between a medium surrounding the raster and the body of the raster, or at a boundary between the first and second layers of the raster body, as the case may be.

However, in certain other examples of rasters according to such first or third embodiments, it may be preferred that the angles adjacent the base of each isosceles triangle of each prism element are substantially non-equal to a critical angle of total internal reflection at a boundary between a medium surrounding the raster and the body of the raster, or at a boundary between the first and second layers of the raster body, as the case may be.

Likewise, in some examples of rasters according to the second or fourth embodiments, a non-right angle adjacent the base of each right triangle of each microprismatic element of each prism element may be substantially equal to a critical angle of total internal reflection at a boundary between a medium surrounding the raster and the body of the raster, or at a boundary between the first and second layers of the raster body, as the case may be.

However, in certain other examples of rasters according to such second or fourth embodiments, it may be preferred that the non-right angle adjacent the base of each right triangle of each microprismatic element of each prism element is substantially non-equal to a critical angle of total internal reflection at a boundary between a medium surrounding the raster and the body of the raster, or at a boundary between the first and second layers of the raster body, as the case may be.

In some examples of rasters according to the first or third embodiments, boundary limit light rays of total internal reflection from each of the two sides of each prism element may be substantially parallel to one another and directed substantially in a direction perpendicular to the planar face of the first side of the body of the raster.

However, in certain other examples of rasters according to such first or third embodiments, it may be preferred that the boundary limit light rays of total internal reflection from each of the two sides of each prism element are substantially non-parallel to one another and directed substantially in a direction non-perpendicular to the planar face of the first side of the body of the raster.

Likewise, in some examples of rasters according to the second or fourth embodiments, boundary limit light rays of total internal reflection from the hypotenuse of each prism element may be substantially parallel to one another and directed substantially in a direction perpendicular to the planar face of the first side of the body of the raster.

However, in certain other examples of rasters according to such second or fourth embodiments, it may be preferred that the boundary limit light rays of total internal reflection from the hypotenuse of each prism element are substantially non-parallel to one another and directed substantially in a direction non-perpendicular to the planar face of the first side of the body of the raster.

The above various possibilities, and respective advantages or disadvantages, of the angle(s) at the base of each triangular prism element and the orientation of boundary limit light rays of total internal reflection are discussed in more detail hereinbelow.

In many practical examples of prismatic rasters according to the various embodiments of the first aspect of the invention, the raster is preferably in the form of a sheet or film of polymeric material.

Preferably mono-layer rasters according to the above-defined first and second embodiments may further comprise a substantially planar, preferably a substantially flat, preferably transparent polymer layer or film attached to the second side of the raster body, e.g. along its perimeter, in order to close its prismatic (or microprismatic) relief and thus provide enhanced protection and resistance against wear or damage or unauthorised copying and protection against ingress of dirt or contaminants . Such an affixed polymer layer or film, together with the raster body itself, may then for example be cut out in accordance with a suitable required size, so the protected raster is ready for use.

Preferably such an additional polymer layer or film is of a polymer, such as e.g. PET or polyethylene. Any suitable thickness of such an additional polymer layer or film may be employed. However it is preferred that such a thickness is at least equal to the thickness of the prismatic raster itself. However, in some cases this thickness may be greater than the depth of the prismatic element relief, as determined by the precision of production equipment such that it does not cause an unnecessary expense of polymer material. Moreover, any suitable affixation method may be used to attach the additional polymer layer or film to the raster body, preferably at least along or around its perimeter, for example by bonding with a suitable adhesive.

Preferably mono-layer or dual-layer rasters according to the above-defined first and second, or third and fourth, embodiments, including those carrying (or not carrying) the above-defined additional polymer layer or film, may further comprise an attachment layer attached to the first side of the raster body. Such an attachment layer may preferably comprise a self-adhesive glue, e.g. with notched or un-notched anti-adhesive material, preferably comprising a silicone coating, or a heat-settable adhesive, and may be attached to the first side (i.e. the output side) of the raster body in readiness for its subsequent attachment to a transparent substrate.

In this connection it may be noted that such mono-layer or dual-layer rasters may typically have a relatively small thickness, e.g. approximately 10 microns. In the printing industry, where interlaced images are printed for example onto paper, there is often a need for fast control over the quality of these images. In order to do this, it is necessary to attach the prismatic raster to the interlaced images. Even if the raster is so very thin, then this can still Lie done. For this purpose theretore, the extra “attachment layer”, e.g. typically of a thickness of about 500 microns, is preferably used, and is located on top of the output layer of the raster body.

In a second aspect of the present invention, there is provided, in combination, a mono- or a dual-layer raster according to any of the first, second, third or fourth embodiments of the first aspect, together with the said array of a plurality of interlaced stripes of left- and right-images of a stereo pair of images which is to be viewable as the said stereoscopic image, the said array being attached to or applied to the second side (i.e. the input side) of the raster body.

The said array may be applied, e.g. by printing, directly onto the second, input side of the raster, or alternatively may be carried on a carrier which is attached to the second, input side of the raster body and having printed thereon the said array of a plurality of interlaced stripes of left- and right-images of a stereo pair of images which is to be viewable as the said stereoscopic image. Where a carrier is used, the said interlaced stripes are preferably printed on the carrier medium or layer, e.g. selected from paper, plastics material or any other suitable printable carrier material, which is preferably affixed to the raster body by a suitable adhesive or other bonding means.

The said array of a plurality of interlaced stripes of left- and right-images of a stereo pair of images may be formed by pixels applied to the carrier medium or layer by any suitable known printing technique. Such printed pixels may be pixels of any suitable ink or other known pixel printing substance, or they may be holographic pixels applied by any suitable known holographic printing technique. Practical examples of such printing or holographic printing techniques are well-known in the art.

In all such combinations of a raster with a printed array of interlaced left- and right-stereo images according to this second aspect, the said stereo image period (which is frequently called the “halftone period”) may be selected according to a consumer's or a user's requirements and/or the type of end-product that the combination is to constitute.

The above-defined combinations of the second aspect of the invention lend themselves usefully to a continuous printing production process for the production of autostereoscopically viewable stereo images in accordance with the invention.

Although, as noted above, many mono-layer or dual-layer rasters according to the first aspect of the invention may typically have a relatively small thickness, e.g. of the order of ˜10 microns, it is possible within the scope of the invention to provide rasters having relatively more macroscopic dimensions of the raster period frequency, for example, up to ˜1 lpi. Such rasters may have, instead of the typical plurality of relatively narrow bands of interlaced images, only one pair of adjacent broad bands of interlaced images, or possibly even more than one, e.g. several, pairs of relatively broad adjacent bands of the macro-interlaced printed images.

Such an arrangement may make it possible to ameliorate or at least partially overcome one of the main problems of making stereo images, namely the need for accurate alignment, for example the alignment of the cylindrical axes of the lenticular lenses of the raster stripes to the direction of the interlaced image. It should also be noted that because of the small raster period frequency proposed in this embodiment, e.g. ˜1 lpi, it may be possible to manufacture stereoscopic images composed of a large number of stereo angles. The result may be a very high quality multi-angle stereoscopic image, and so this arrangement may find advantageous use for instance in stereo photography.

In a third aspect of the present invention, which in essence comprises alternative embodiments of the above-defined second aspect, there is provided, in combination, a said mono- or dual-layer raster according to any of the first, second, third or fourth embodiments of the first aspect, together with a backing layer attached to the second side (i.e. the input side) of the raster body, which may preferably comprise a self-adhesive glue, e.g. with notched or un-notched anti-adhesive material, preferably comprising a silicone coating, or a heat-settable adhesive. The backing layer may itself subsequently be attached to the aforementioned carrier medium or layer (if used) bearing the printing pixels constituting the interlaced stripes of the left- and right-stereo pair images.

Such embodiment combinations of this third aspect of the invention lend themselves usefully to a separate or discrete printing production process for the production of individual autostereoscopically viewable stereo images in accordance with the invention.

Raster and carrier- or backing-layer combinations according to the above-defined second or third aspects of the invention may be attachable or affixable to a surface of any desired or suitable object or product which is to carry or be provided with the autostereoscopically viewable stereo image in accordance with the invention. The said surface of the object may be substantially flat or planar, or it may be curved, e.g. it may be convex or concave. An example of the latter is a concave dished plate. Means for such attachment or affixation may comprise a layer of self-adhesive glue, e.g. with notched or un-notched anti-adhesive material, preterably comprising a silicone coating, or a heat-settable adhesive, applied directly or indirectly to the second side (i.e. the input side) of the raster body.

The same attachment or affixation means may likewise be used to attach or affix rasters according to embodiments referred to above that include an attachment layer attached to the first side of the raster body.

In prismatic rasters or combinations including prismatic rasters according to various embodiments of the invention, in cases where an additional layer of optical material, e.g. a polymer layer or film, is applied onto the first side (i.e. the output side) of the raster body, this additional layer preferably has a refractive index n which is less than the efractive index nₒ of the prism material (in the case of a mono-layer raster), or in the case of a dual-layer raster is preferably less than the refractive index nₒ of the material of the first (output) raster layer. A purpose of this criterion is to assist in the reduction of loss of light, or in other words to serve to increase the brightness of the stereo imaging.

For many practical applications, prismatic rasters or combinations including rasters according to various embodiments of the invention may have their first (output) raster body sides optionally printed with indicia, information or one or more images. Such indicia etc may be applied by any suitable conventional printing technique, e.g. using a suitable ink or other known printing substance, or they may be holographic indicia applied by any suitable known holographic printing technique. Practical examples of such printing or holographic printing techniques are well-known in the art. By use of this technique it is possible to print the rasters or raster-including combinations with normal or regular 2D images, for example for information or promotional purposes, on the output side (i.e. output plane) thereof. Such images will thus normally always be visible to the eye of the user, as they cannot be blocked by the stereo imaging mechanism.

In any or all embodiments of the invention, the raster or combination including the raster may additionally comprise one or more, or one or more sets of, framing darts.

Such framing darts may typically be applied onto the prismatic raster outside of the future stereo image at the time the raster is manufactured, and are preferably oriented so as to be perpendicular to the long sides of the raster's prismatic elements (i.e. to the longitudinal axis of the raster). The framing darts may for example take the form of matte or holographic lines, formed at the stage of producing the master-matrix for the raster. The framing darts may be applied for example as pixels using any suitable known printing technique. Such printed pixels may be pixels of any suitable ink or other known pixel printing substance, or they may be holographic pixels applied by any suitable known holographic printing technique. Practical examples of such printing or holographic printing techniques are well-known in the art.

In a fourth aspect of the present invention there is provided a method of manufacturing a prismatic or a microprismatic raster according to the first or second embodiments, respectively, of the first aspect, the method comprising:
(i) producing a preferably sculptured profile of a predetermined form, depth and period on a substantially flat surface of an original matrix set;
(ii) making a metal master matrix, preferably using a galvanic process; and
(iii) multiplying the prismatic raster a desired number of times by moulding e.g. polymer material(s) with the required refractive index (or indices) of the respective layer(s).

In first preferred embodiments of the above-defined method of the fourth aspect, the method comprises the steps of:
(i) producing a sculptured profile of a predetermined form, depth and period on the flat surface of the original matrix set;
(ii) making a metal master matrix using a galvanic process; and
(iii) multiplying the prismatic raster the desired number of times using UV and cold-setting varnish(es) or adhesive(s) with the required refractive index(ices).

In second preferred embodiments of the above-defined method of the fourth aspect, the method comprises the steps of:
(i) producing a sculptured profile of a predetermined form, depth and period on the flat surface of the original matrix set;
(ii) making a metal master matrix using a galvanic process; and
(iii) multiplying the prismatic raster the desired number of times by stamping out polymer film(s) with the required refractive index(ices), optionally including films not completely covered with a polymer UV layer of a hardening varnish or glue.

Suitable galvanic and other process steps for use in the above embodiment methods may include any of the following:
(a) Various known origination techniques may be used, e.g.:
   mechanical engraving: material e.g. aluminium on a glass substrate;
   optical interference recording: material e.g. photo-resist on a glass substrate;
   e-beam writing and lithography (multilevel or grayscale processes): material e-beam resist (e.g. PMMA (polymethylmethacrylate)) on silicon or glass substrate (e-beam writer producers include e.g. Raith, Vistec, Jeol).
(b) Known electroforming or electroplating processes, e.g. in the CD/DVD industry or mass production of embossed holograms: materials e.g. chromium or nickel. Some such processes have been known since as early as the 1850's.
(c) Known moulding, embossing or casting processes, where the master matrix (e.g. chromium, nickel) is mechanically replicated (usually at elevated temperature and pressure) to the plastic material, e.g. PET (polyethylene terephtalate), PC (polycarbonate) (e.g. “Lexan” from SABIC Innovative Plastics, “Macroclear” from Arla Plast), UV-curable polymers (e.g. “OrmoComp” from Micro Resist Technology, GmbH).

In a fifth aspect of the present invention there is provided a method of manufacturing a dual-layer prismatic or a microprismatic raster according to the third or fourth embodiments, respectively, of the first aspect, the method comprising:
(i) producing a prismatic or a microprismatic raster according to the method of the fourth aspect; and
(ii) applying or affixing to said raster produced in (i) one or more additional layers of material, e.g. of a polymer, of a predetermined suitable thickness, such that the material of the raster body and the additional layer(s) have the respective required refractive indices nᵢ.

Suitable methods for such application or affixation of such additional polymer layers are well-known in the art.

In a sixth aspect of the present invention there is provided an autostereoscopic image printing apparatus including a raster according to the first, second, third or fourth embodiments of the first aspect, or a combination according to the second or third aspects.

In preferred embodiments of such printing apparatus, the apparatus may further include a built-in digital camera and software that allows adjustment of long sides of the interlaced images perpendicular to framing darts (where used) of the prismatic raster when preparing to print.

In a seventh aspect of the present invention there is provided one or more rasters according to the first aspect or one or more combinations according to the second or third aspects, additionally including reference lines corresponding to framing darts, as discussed above, and interlaced images printed using the apparatus according to the sixth aspect.

The above sixth and seventh aspects of the invention may provide rasters especially suitable for home manufacture of autostereoscopically viewable stereo images.

Within the scope of this application it is envisaged that the various aspects, embodiments, examples and alternatives set out in the preceding paragraphs and/or in the following description and drawings, and in particular the individual features thereof, may be taken independently or in any combination, unless the context otherwise requires, whilst remaining within the scope of the invention as defined in the appended claims. For example, features disclosed in connection with one embodiment are applicable to all embodiments, unless there is incompatibility of features or the context otherwise requires, whilst remaining within the scope of the appended claims.

### BRIEF DESCRIPTION OF THE DRAWINGS

Further features, embodiments and aspects of the invention will be apparent from the following detailed description of the invention and embodiments thereof, which are all presented by way of example only, taken in conjunction with the accompanying drawings (some of which have already been referred to), in which:

FIG. 1 is a simplified schematic representation of the optics of a real stereoscopic effect (FIG. 1a) and an artificial stereoscopic effect (FIG. 1b);

FIG. 2 is a schematic representation of the paths of boundary light rays in a one-view zone of a parallax barrier raster, as in [5, 6];

FIG. 3 is a schematic representation of the paths of boundary light rays in a one-view zone of a lenticular raster, as in [6];

FIG. 4 is a representation of the creation of a total internal reflection phenomenon in a flat glass plate;

FIG. 5a is an explanatory cross-sectional view of a biprism showing the phenomenon of total internal reflection of light from a pixel in the biprism;

FIG. 5b corresponds to FIG. 5a, but shows the biprism in an inverted configuration, again showing the phenomenon of total internal reflection of light from a pixel in the inverted biprism;

FIG. 6 is an explanatory cross-sectional view of an arrangement including a total internal reflection prism of a raster in accordance with an embodiment of the invention in combination with printed bands of interlaced stereoscopic images, showing the paths of light rays in the total internal reflection prism directed towards the right eye (only, for clarity) of an observer;

FIG. 7 is an explanatory cross-sectional view of another arrangement including a total internal reflection prism of a raster in accordance with an embodiment of the invention in combination with printed bands of interlaced stereoscopic images, showing the paths of light rays in the total internal reflection prism directed towards both the right and the left eyes of the observer;

FIG. 8 is a schematic close-up, zoomed-in view of the region of the arrangement of FIG. 7 adjacent the total internal reflection border;

FIG. 9a is a schematic perspective view of an inverted prismatic raster in accordance with a first embodiment of the first aspect of the invention;

FIG. 9b is a schematic cross-sectional view of the raster of FIG. 9a shown in a working position in combination with printed bands of interlaced stereoscopic images;

FIG. 10 is a schematic diagram showing the arrangement of Fresnel-type planar microprisms for use in a prismatic raster according to a second embodiment of the first aspect of the invention;

FIG. 11a is a schematic perspective view of an inverted Fresnel-type bidirectional prismatic raster in accordance with the second embodiment of the first aspect of the invention;

FIG. 11b is a schematic cross-sectional view of the Fresnel-type bidirectional prismatic raster of FIG. 11a shown in a working position in combination with printed bands of interlaced stereoscopic images;

FIG. 12a is a schematic perspective view of a flat two-layer prismatic raster in accordance with a third embodiment of the first aspect of the invention;

FIG. 12b is a schematic perspective view of a flat two-layer Fresnel-type bidirectional raster in accordance with a fourth embodiment of the first aspect of the invention;

FIG. 13 is a schematic representation of the paths of boundary light rays in a one-view zone of the prismatic flat raster as shown in FIG. 12a;

FIG. 14 corresponds to FIG. 13 and is a schematic representation of the paths of oblique limit light rays in the one-view zone of the prismatic flat raster as shown in FIG. 12a, analogous to use of an equivalent lenticular raster whose notional position is represented in phantom lines;

FIG. 15 is a schematic representation of the paths of limit light rays in a one-view zone of a prismatic dished plate raster in accordance with another embodiment of the first aspect of the invention.

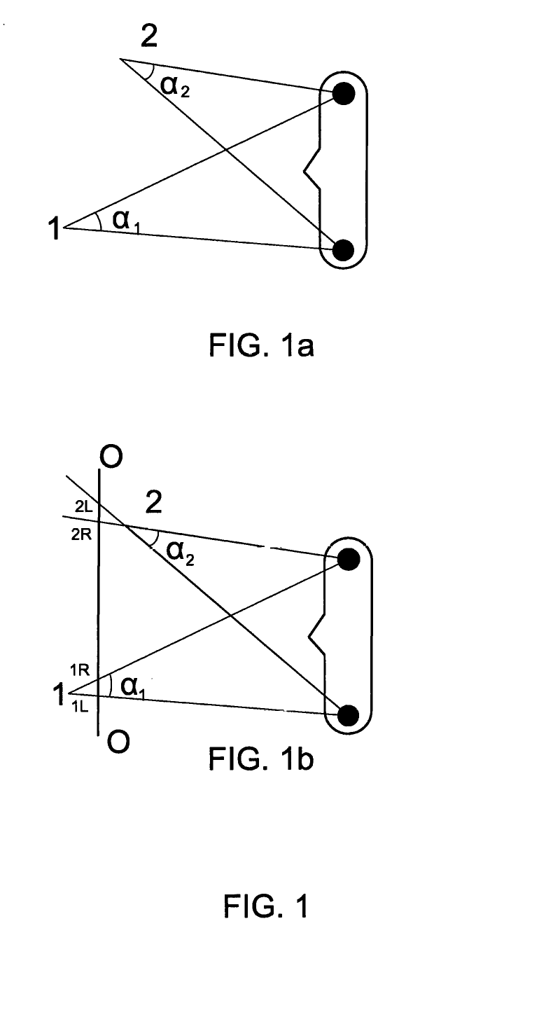

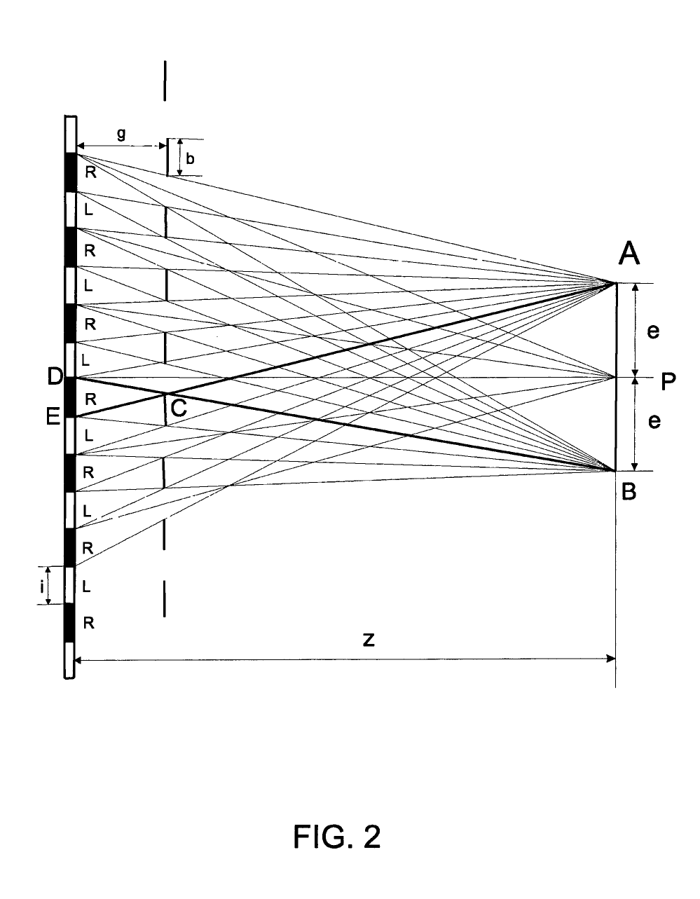

### DETAILED DESCRIPTION OF THE INVENTION AND EMBODIMENTS THEREOF

The present invention is based on the effect of total internal reflection. As a phenomenon this was originally discovered by Johannes Kepler in ˜1600 and is well-known today in the field of optics. There are several known applications of this effect:
1. Total internal reflection is applied in the construction of rotating glass prisms and reversing glass prisms. The critical angle for such prisms is in the approximate range of 35°-45°, the actual critical angle depending on the refractive index of the glass or other material from which the prism is formed. Therefore, such prisms can be used without complications with appropriate selections of entrance and exit angles.
2. Total internal reflection is used and considered in the designing and manufacturing of reflective elements.
3. Total internal reflection is used and considered in the designing and manufacturing of fibre-optic lines.
4. Developments and advancements in display techniques have hitherto led to the usage of total internal reflection effects mostly in screen highlighting units [18, 19, 20].
5. Total internal reflection is widely used in scientific research, particularly in spectroscopy of frustrated total internal reflection, in which case of total internal reflection an optical field does not break at the media border, but penetrates into the medium and contains information about the optical features of materials which are contiguous with a reference material.

The essence of total internal reflection is as follows:

When falling on the border between two media, light is divided into two parts: one part is reflected, and another part penetrates through the border from the first medium into the second medium and undergoes refraction. As an example, in the case of a light transition from air to glass, i.e. from a medium with a lower optical density to a medium of a higher optical density, the proportion of the light that is reflected depends on the incident angle. In this case the proportion of the light that is reflected essentially increases with an increase in the incident angle. However, even at very large incident angles, e.g. close to 90°, when the light beam is almost skimming along the interface between the two media, some proportion of the light energy still passes into the second medium as refracted beams. Nevertheless, as the incident angle increases there is a smaller corresponding increase in the refraction angle, and as a result some critical or limit angle β₀ is eventually reached, in accordance with Snell's Law:

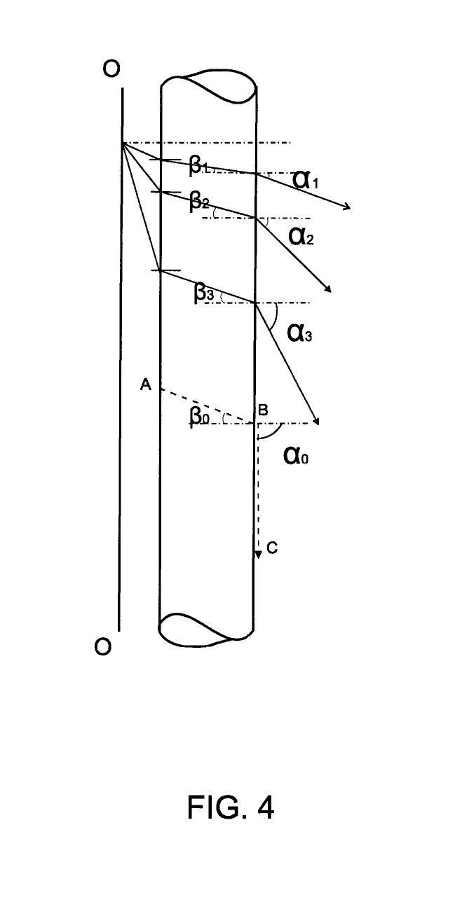

nₐ sin α=n_{b} sin β (9)

where β is the incident angle and α is the refraction angle at the interface between the two media with respective refractive indices n_{b} and nₐ. This system is shown in FIG. 4 of the drawings, where light beams are falling on a glass plate from the air.

An interesting effect may be observed if light distributed in some optically-dense medium meets the interface with a less optically-dense medium which has a lesser refractive index. In this case the reflected part of the light energy increases together with the increase in incident angle, but the increase is defined by another rule: beyond a particular given incident angle, all the light energy reflects from the interface. Such an effect is known as total internal reflection.

As shown in FIG. 4, consider the incidence of light on the glass-air interface from the glass plate direction, and assume that the light beam from the O-O plane, where a light source is located, meets the glass-air interface with different incident angles β (i.e. β₁, β₂, β₃, . . . etc). Incident angle β₀—at which all the light energy is reflected from the interface—is the critical angle of total internal reflection.

At the incidence of light on the interface with a critical angle of total internal reflection β₀ the refraction angle α₀ is 90°, i.e. in the case of skimming incidence α=90° for the above refraction law characterising equation (9), which means that:

sin β₀=nₐ/n_{b} (10)

If incident angles are larger than β₀, then a refracted beam does not exist and light does not leave the plate. In this case the ABC beam is the critical beam of total internal reflection.

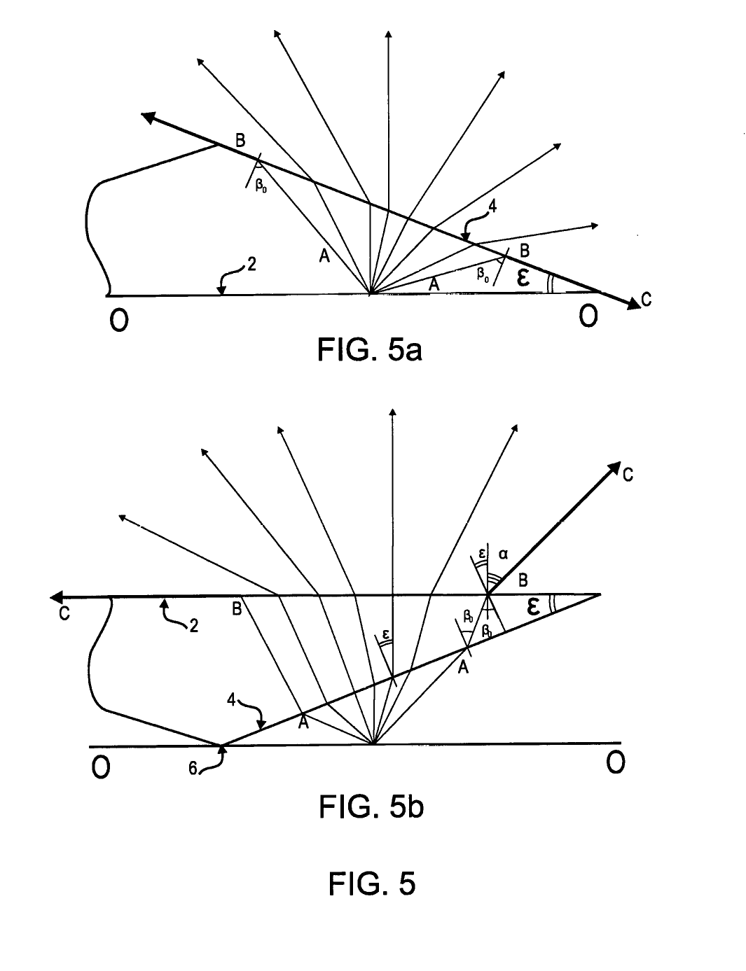

Going further, and as shown in FIG. 5a, the transition of beams in a biprism of the same glass as the glass plate of FIG. 4 with a small angle c at its base 2, set on the source O-O plane, may be envisaged. In this case the numerical values of both β₀ angles are not changed, and critical beams skim symmetrically along the side surfaces 4 of the biprism. These ABC beams are the borders of total internal reflection.

Now, instead of the biprism of FIG. 5a, consider the transition of beams in an oblique prism made of the same glass with an angle c at its base which is slightly less than the β₀ critical angle. If this prism is inverted so that its vertex 6 is located on the source O-O plane, as shown in FIG. 5b, in this case beams from the source O-O plane are generally deflected in the direction of the observer's right eye. However, a critical beam ABC leaves the prism through its base 2 at an angle a and limits the entering of outgoing light to the left eye of the observer.

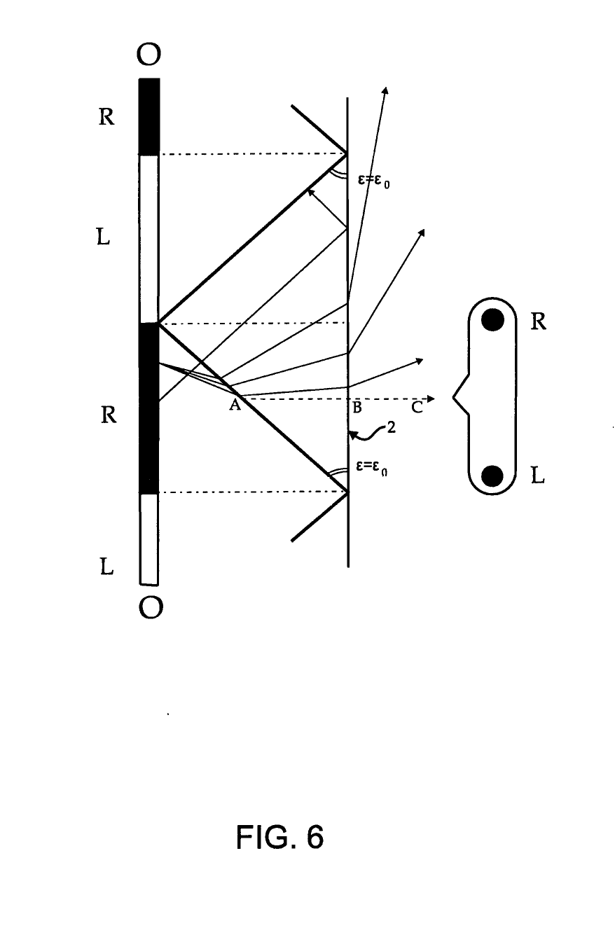

FIG. 6 shows schematically an arrangement including part of a raster in accordance with an embodiment of the invention. As shown in FIG. 6, if the angle at such a prism base 2 is ε=β₀=ε₀, then the critical beam ABC leaves the inverted prism along the normal to its base plane and corresponding limitation of light entering the left eye of the observer happens as it does in the arrangement of FIG. 5b.

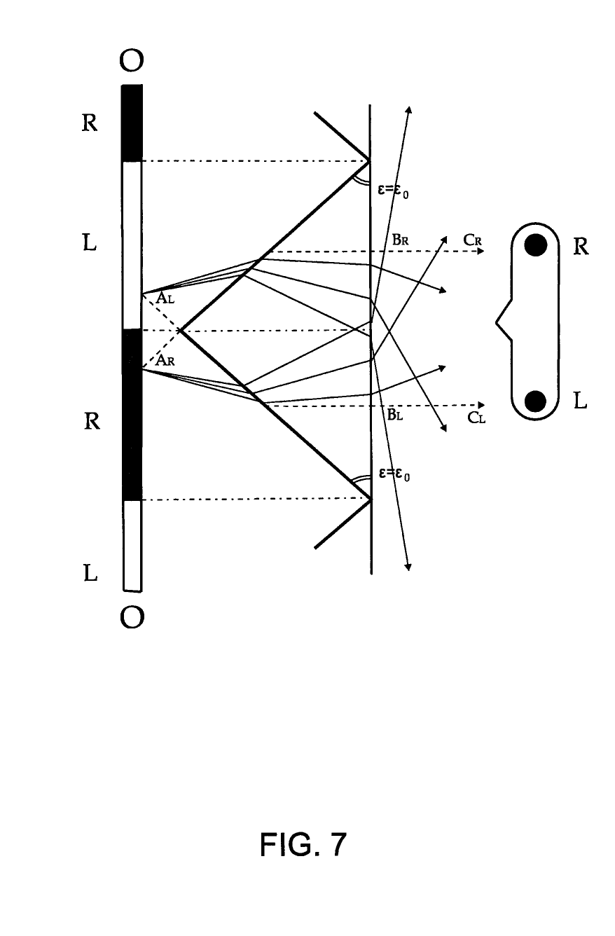

A full picture of light beams passing through a prism whose angles at its base are ε=β₀=ε₀, is shown in FIG. 7. As can be seen, the beam's transition in the total internal reflection prism complies with the divided vision principle. This means that a total internal reflection prism can be used as an optical element in order to create an artificial stereoscopic effect. This is the essence of the present invention.

The present invention thus has as its main object to provide thin-layer patterns forming autostereoscopic images for use in both the printing industry and for home use. In embodiments of the invention typical thicknesses of the proposed prismatic rasters, and hence typical thicknesses of resulting autostereoscopic images, may be for example up to about 10 microns, which is comparable with typical thicknesses of holographic labels.

Such reduced thicknesses are an important advantage over lenticular rasters as commonly found in the prior art. Furthermore the proposed autostereoscopic images according to the present invention may have natural colour, which is an important advantage over known holographic labels.

The present invention thus proposes the use of special prisms for the formation of autostereoscopic images. The total internal reflection phenomenon occurs on the sides (or hypotenuses) of those special prisms. In this manner the principle of separating left and right interlaced views is implemented and stereo pair images are created. Implementation of this principle is particularly important in the case of printing with light-scattering pixels, as well as in creating 3D displays. Otherwise, the value of left/right image crosstalk would abruptly increase, which would lead to a significant deterioration in the quality of the autostereoscopic images observed or produced.

The proposed cross-sectional geometry (or geometries) of prismatic raster elements according to embodiments of the present invention has/have hitherto not been applied for addressing or solving the problems discussed hereinabove in relation to the prior art when creating autostereoscopic images in general, and in particular not in the fields of printing or 3D displays. The use of known prismatic-type rasters of the prior art in the manufacture of 3D displays has hitherto been restricted basically to their use as a deflector, in which light rays are directed alternately into one eye and then the other eye of the observer. In contrast, according to the present invention both the left and right sides of the stereo images enter the left and right eyes of the observer simultaneously, but separately. This is a fundamental and unique feature characteristic of the present invention for the realisation of autostereoscopic images, especially those in printed form.

In other words, the essence of the novelty of the present invention lies in the fact that the prismatic rasters of the invention use the principle of total internal refection (TIR) to achieve an effective splitting of the left and right stereo images that reach the respective eyes of the observer, instead of the idea of mere refraction at an interface, as used in many known prior art stereoscopic display arrangements. In effect, and expressed somewhat loosely, in the present invention a “right half” of the raster “disables” the rays coming from the “left pixels”, and a “left half” of the raster “disables” the rays coming from the “right pixels”—each of these effects happening simultaneously so that the left and right images are delivered to the respective left and right eyes simultaneously.

In addition, unlike some prior art autostereoscopic displays which e.g. rely on a direction-controlled illumination unit, use of the prismatic rasters of the present invention enables the production of autostereoscopic printed images without the need for a special lighting unit, which necessarily has an associated power source and control unit, and so an inevitably higher power consumption. In contrast, the present invention can be put to practical use using normal ambient lighting.

Moreover, in their broadest terms the autostereoscopic prismatic rasters according to the present invention may be further understood by appreciating the following:

Printed pixels scatter their light in all directions. Because of this, in the printing industry the conventional use of known refracting prisms cannot be used to produce 3D images, since the light from the “right” pixels can smoothly get into the left eye of the observer, and the light from the “left” pixels can smoothly get into the observer's right eye. This can lead to 3D images of poor quality owing to the high crosstalk between the left and right images, or even to a complete inability to properly observe a 3D image.

This is the main difference and advantage of the prismatic elements of the rasters of the present invention, which have a TIR geometry, because the correctly calculated TIR border (i.e. obtained or arising from a correct geometry of the prismatic shape and/or configuration, the element's material(s) and the intended observer's relative position) automatically performs a selection of light from “right” and “left” pixels. This is demonstrated in FIGS. 6 and 7 of the accompanying drawings, and already discussed above.

Thus, in prismatic rasters according to the present invention in its broadest defined terms, in each prismatic optical element there is preferably provided a flat face having its own inclination corresponding to a given TIR angle, which allows the observation of a given 3D image at different angles. As a result the angular range or zone within which the 3D image is observable by the viewer may be significantly expanded, thereby creating a complete analogy of the real object. It may also be possible to observe such a 3D image simultaneously by several observers.

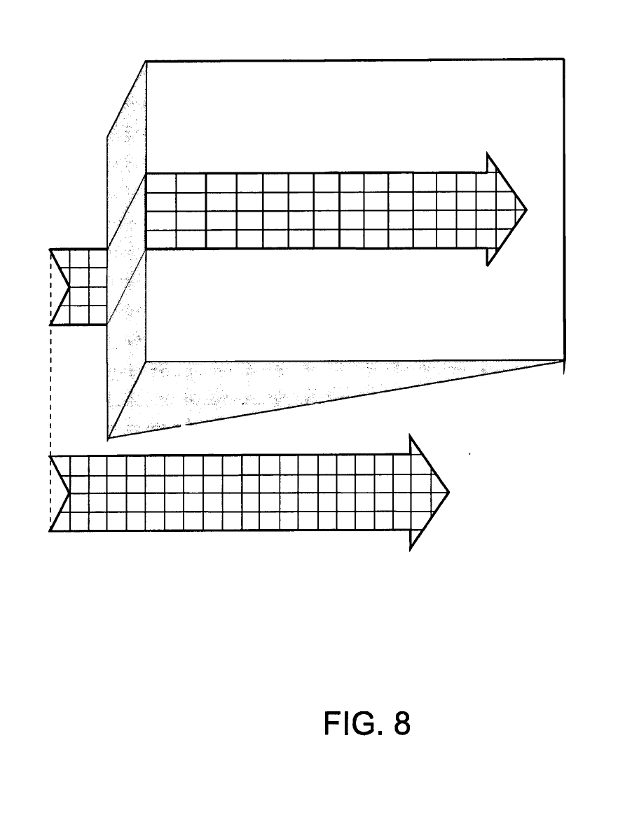

To observe the above-described processes as illustrated in FIG. 7, a model experiment was conducted. A rotating 90° crown-glass prism with n=1.48 (β₀=2.5° was selected and was placed upon its vertex above some text placed in the O-O plane as shown in FIG. 7. Although the base angles of this prism are ε=45° and differ from the calculated prism geometry by 2.5°, a slightly zoomed-in 1.6× direct image was observed, as shown in FIG. 8. During this process the previous part of text was observed by the right eye and the following part was observed by the left eye. This observation corresponds excellently to the above description of total internal reflection optics.

Some image zooming is explained by the well-known fact of prismatic zooming-in and optical wedges in a direction perpendicular to the refracting edge of a prism. In this case the diameter of the light beam with extended and enlarged lateral dimensions is equal to the diameter of cross-section of the narrow beam which strikes upon the prism plane surface in this plane.

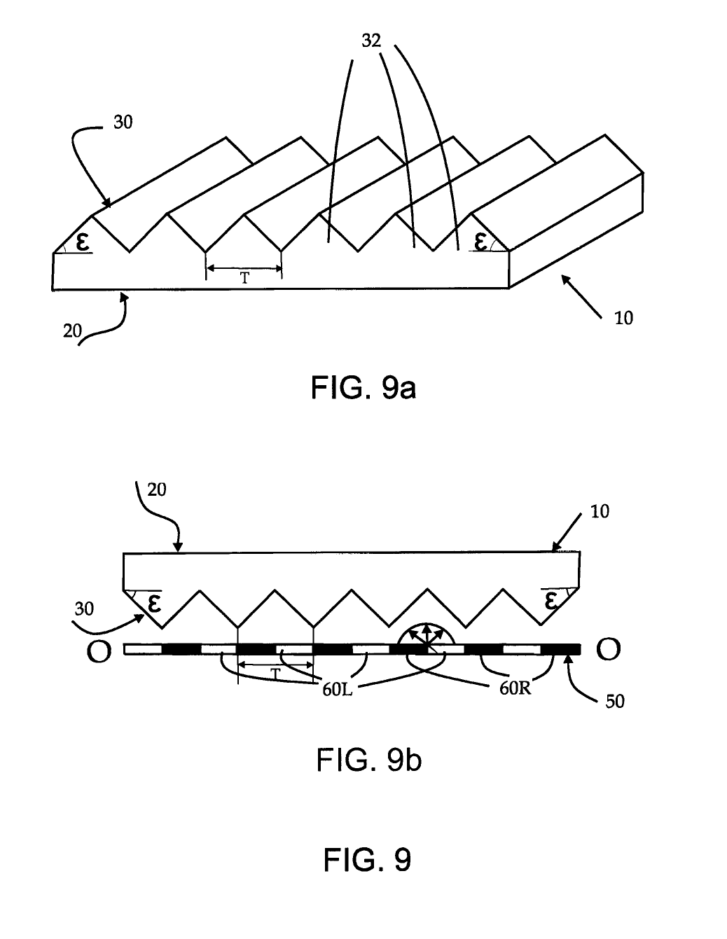

Up to this point we have not considered the issue of dimensions of a total internal reflection prism. It will be readily appreciated however that the dimensions of such a prism for practical use should, as a minimum, correspond to the typical dimensions of lenticular rasters with a cylindrical prism frequency of about 100 lpi, or approximately T=254 μm for one prism. This is illustrated in FIG. 9, which shows a basic form of a prismatic raster 10 according to a first embodiment of the invention.

FIG. 9b shows the raster 10 in its normal working position in combination with a carrier 50 printed with interlaced bands 60L, 60R of a pair of stereoscopic images for viewing through the raster 10. FIG. 9a shows the raster 10 alone, but for a better understanding of this embodiment the raster 10 is shown here inverted so that its flat, normally upper plane 20 is located at the bottom of the drawing and its relief, normally lower, plane 30 is shown uppermost.

In malty practical embodiments of the invention it is particularly desirable to devise autostereoscopic systems using rasters of the basic principle according to the first aspect of the invention which are of thicknesses down to the order of approximately a micron (1 μm) or thereabouts. It is therefore desirable to be able to extend application of the invention from larger-scale systems such as prisms with thicknesses of e.g. around 254/2=177 μm, to microprisms with micron-order thicknesses in the approximate range of ˜0.3 to ˜5.0 μm.

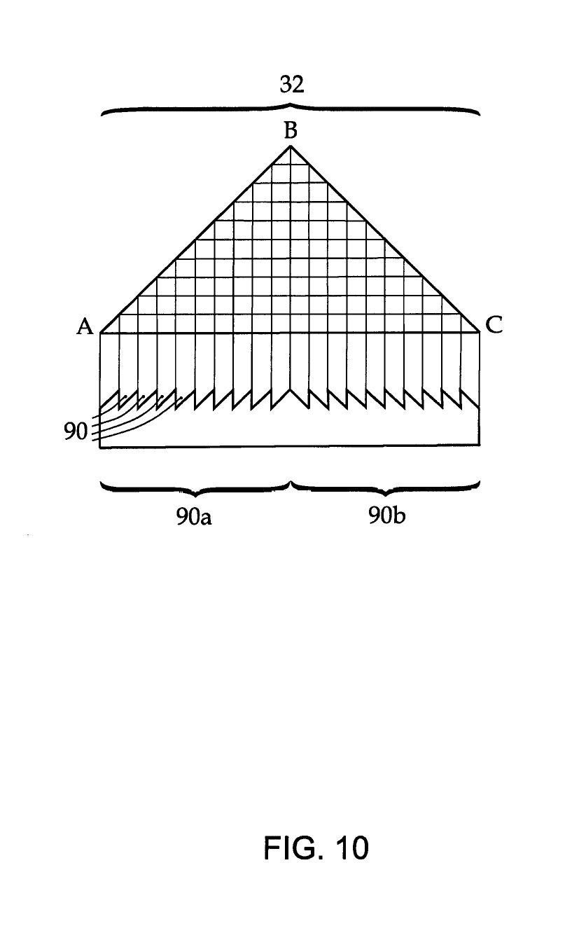

The principle of a Fresnel lens [21] is well-known in optics and it allows one to move from real lenses to much thinner Fresnel planar lenses and in the process to calculate accordingly the geometry of the resulting Fresnel-type microrelief. For its application to the present invention this method of producing a Fresnel-type lens is modified somewhat and is illustrated by way of example in FIG. 10.

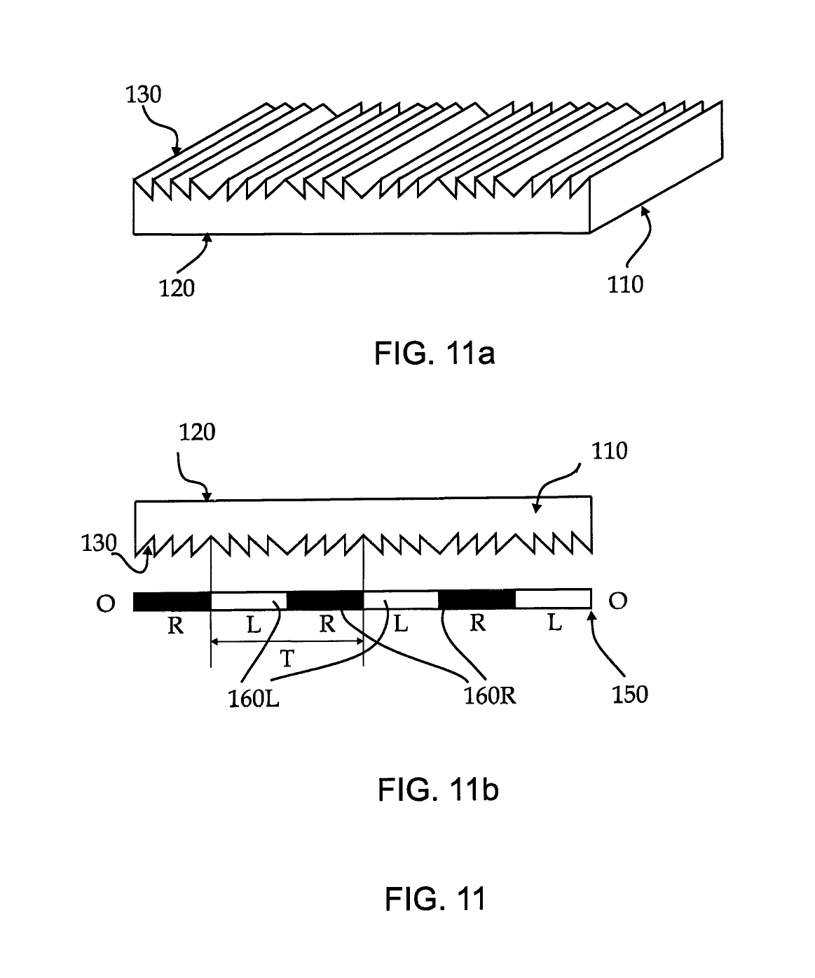

As shown in FIG. 10, the array of Fresnel-type right-triangular microprisms 90 in a single prismatic element 32—which may for example be each of the prismatic elements 32 of the prismatic raster of FIG. 9—comprises two mirror-image sections 90a, 90b within a given period T (see FIG. 11b). The arrangement of Fresnel-type right-triangular microprisms 90 is such that normal lines relative to the hypotenuses of the left-section microprisms in the left half 90a of the period T are directed to the left (i.e. towards an observer's left eye) and normal lines relative to the hypotenuses of the right-section microprisms in the right half 90b of the period T are directed to the right (i.e. towards an observer's right eye). This Fresnel-type microprismatic raster according to the invention can be referred to as “bidirectional”, since the normal lines to the respective sets of hypotenuses are directed in two different directions.

FIG. 11 b shows such a Fresnel-type microprismatic raster 110 in accordance with a second embodiment of the invention in its normal working position in combination with a carrier 150 printed with interlaced bands 160L, 160R of a pair of stereoscopic images for viewing through the Fresnel-type raster 110. FIG. 11a shows the Fresnel-type raster 110 of this second embodiment alone, but for a better understanding of this embodiment it is shown inverted so that its flat, normally upper plane 120 is located at the bottom of the drawing and its Fresnel-type relief, normally lower, plane 130 is shown uppermost.

The number of initial prism height divisions and, therefore, the dimensions of Fresnel microprisms may be defined quite approximately. The main condition influencing the number of divisions is the relatively low height of the Fresnel microprisms which is defined by an optimisation of two opposing requirements, namely:
(i) the necessity of small dimensions—e.g. up to approximately 5 μm—that are required by the application of process technology for microprismatic raster stereo products replication that is similar to the replication process of embossed rainbow holograms, and by the economising of printing expendables such as polymeric varnish; and
(ii) the necessity to use relatively large microprism dimensions on a matrix that can be produced, e.g. by means of microrelief engraving by a diamond tool, and which has to provide the microprism geometry and required optical quality of the produced microrelief.

At the present time there is just one company, Newport Corporation [22], which is able to produce slit right-triangular microprisms with a slit rate of up to ˜3600 slits per mm, which corresponds to microprisms with dimensions approximately 0.278 μm.

This value may thus be accepted as the critical depth of microprismatic rasters at the present time and microprismatic rasters according to the present invention may thus be considered to be a special example of bidirectional relief transmitting diffraction gratings.

The small size of microprisms is a reason for diffraction occurring, so that must also be a reason for the occurrence of diffraction image distortions. This is why it is also in practice desirable, or even necessary, to consider the question of whether or not optical diffraction of interlaced image pixels leads to colour distortion of stereo images, eg. especially discolouration at their edges.

It is for this reason that it may be important to consider the correlation between printing pixels sizes and the dimensions of microprisms used in the present invention. Typical minimal sizes of printed pixels are in the approximate range of from˜20 to ˜40 μm. Therefore ˜100 is the approximate maximum number of 0.278 μm microprisms per one pixel.

It should be noted also that every printed pixel in, for example, an RGB system is a quasi-monochromatic source of diffused light.

Analysis of light diffraction at a diffraction grating on the basis of the Huygens—Fresnel principle is shown in [21] and it allows us to state:
(i) First, diffracted light intensities at every first order are less than 5% of zero order intensity; and
(ii) Second, every single pixel, e.g. in an RGB system, is an almost quasi-monochromatic source of diffused light, and so colour distortion of all stand-alone pixels will not occur. The only effect which will be observed is intermixing by the directions of refracted beams with the same wavelength as the diffracted light beams, and so there will not be any colour distortion of stereo images in microprismatic rasters.

Preferred embodiments of the present invention provide prismatic and microprismatic (especially Fresnel-type) rasters that lend themselves especially well to modern methods used for the replication of optical relief elements.

The present invention may have particular commercial advantages in the sphere of stereo products manufacturing over and above known processes for the manufacture of holographic products. This is explained by the necessity to manufacture a new high-priced master-matrix for every new image in holographic production, whereas for mass production of stereo images it is sufficient to manufacture a few less expensive master-matrices with a spatial raster frequency of about 100 lpi.

Individual parts of a stereo image may be produced by means of cheap polygraphic methods of coloured interlaced images printing. This is where the principal aesthetic advantage of stereo production over holographic images may be realised. On the one hand, stereo images have permanent, natural colours, whereas on the other hand volumetric holographic images are coloured in unnatural rainbow colours which change depending on the change of mutual location of the hologram and the light source.

Prismatic rasters according to the first embodiment of the first aspect of the invention, as exemplified in FIG. 9a, and Fresnel-type bidirectional microprismatic rasters according to the second embodiment aspect of the invention, as exemplified in FIG. 11a, may in their most basic forms have a practical disadvantage, which is that the relief is open, which increases its propensity to damage and wear and to the possibility of unauthorised relief copying.

Thus in further preferred embodiments of the invention, in order to mitigate this disadvantage it is proposed to close the relief surface of such rasters by use of a closure layer comprising a substantially planar, preferably transparent, protective polymer layer or film attached to the second side of the raster body. The protective polymer layer or film is of a polymer having a refractive index nᵢ which is lower than the refractive index nₒ of the optically isotropic material of the raster body. Such a closure layer may be in the form of a flat, transparent polymer film fixed, e.g. by gluing, on the relief surface of the raster, such as around its perimeter. This allows the creation of prismatic rasters placed between two plain surfaces, but with an air layer therewithin. However, certain other disadvantages of such rasters may then occur, in that they may be neither solid nor wholly reliable, and they may also possess superfluous thickness.

Thus, a further development of the idea underpinning the present invention, lying in the use of total internal reflection prisms as optical elements of an autostereoscopic raster, has led the present inventors to design some alternative forms of raster according to other embodiments of the invention, which take the form of solid optical blocks with two plain outer surfaces and possess the same prismatic properties.

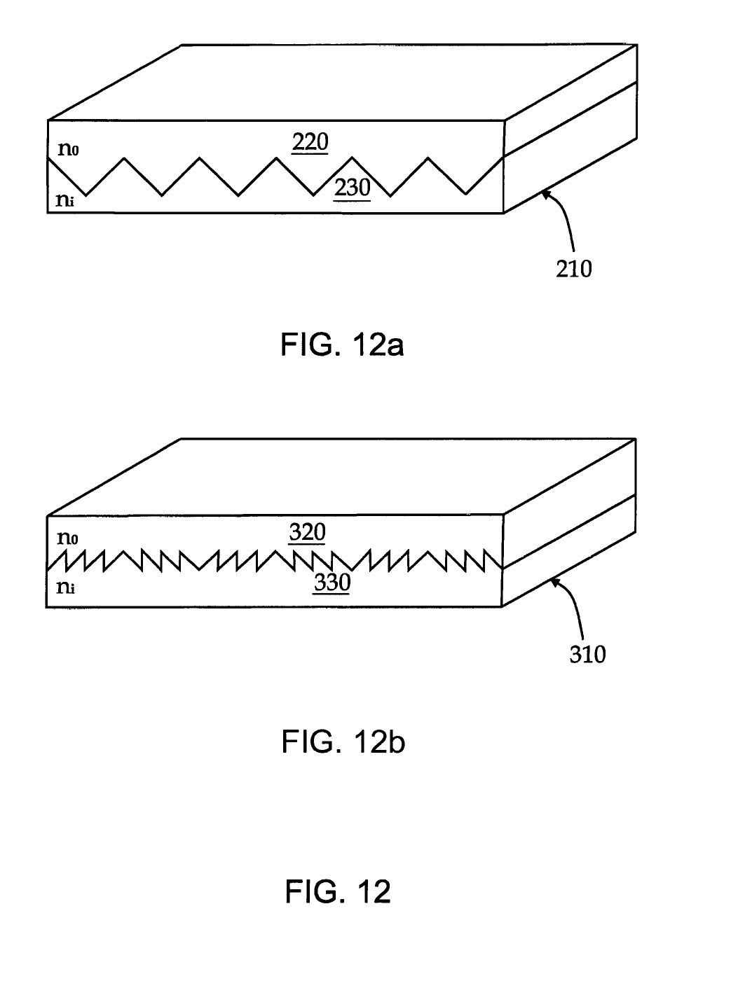

Accordingly, according to the third and fourth embodiments of the first aspect of the invention defined above there are provided, respectively, a dual-layer prismatic raster and a dual-layer Fresnel-type microprismatic raster. These embodiments are illustrated schematically in FIG. 12, in which FIG. 12a shows an example of a dual-layer prismatic raster according to the third embodiment and FIG. 12b shows an example of a dual-layer Fresnel-type microprismatic raster according to the fourth embodiment.

In both these structures of FIG. 12, which may each be thought of as taking the form of a flat slab, the upper layer with total internal reflection prisms with refractive index no is in optical contact with an additional, lower, prismatic layer which has refractive index nᵢ, with the condition satisfied that nᵢ<nₒ. Thus:
(i) In the two-layer prismatic raster of FIG. 12a, both angles at the bases of the respective isosceles triangles at the planar base of each prism are, preferably for example, substantially equal to the total internal reflection angle at the interface between the upper 220 and lower 230 layers; and
(ii) In the two-layer Fresnel-type microprismatic raster of FIG. 12b, one angle (i.e. the non-right angle) at the base of the respective right triangles at the planar base of each microprism is, preferably for example, substantially equal to the total internal reflection angle at the interface between the upper 320 and lower 330 layers.

Such types of dual-layer autostereoscopic prismatic rasters may be called “plain”. It is logical to call the prismatic layer with refractive index nᵢ the “incoming” layer, and the layer with refractive index nₒ the “outgoing layer”, in accordance with the direction of transition of the respective interlaced stereoimages' pixels' light beams that pass therethrough upon viewing.

So, the two preferred principal conditions for two-layered prismatic raster functioning are as follows:
(i) The refractive index nₒ of the outgoing layer should be greater than the refractive index nᵢ of the incoming layer; and
(ii) The non-right-angle angle(s) at the bases of the respective isosceles or right (as the case may be) triangles at the base of each prism or microprism (as the case may be) should preferably be equal to the total internal reflection angle at the interface between the two layers.

Preferred rasters according to the first, second, third and fourth embodiments of the first aspect of the invention have a further common feature as follows: the total internal reflection limit boundary rays of each pixel are perpendicular to the exit raster plane, and the rest of the rays from pixels are spread at angles varying from +/−0° to +/−90°, forming continuous sheaves of spreading rays. This arrangement is characteristic of flat rasters, i.e. rasters with a generally straight longitudinal axis.

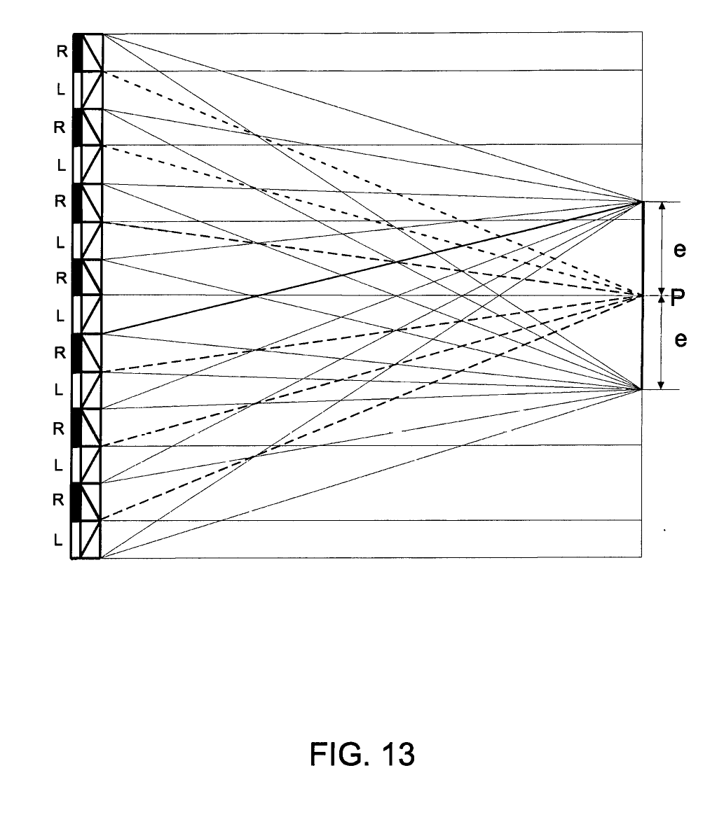

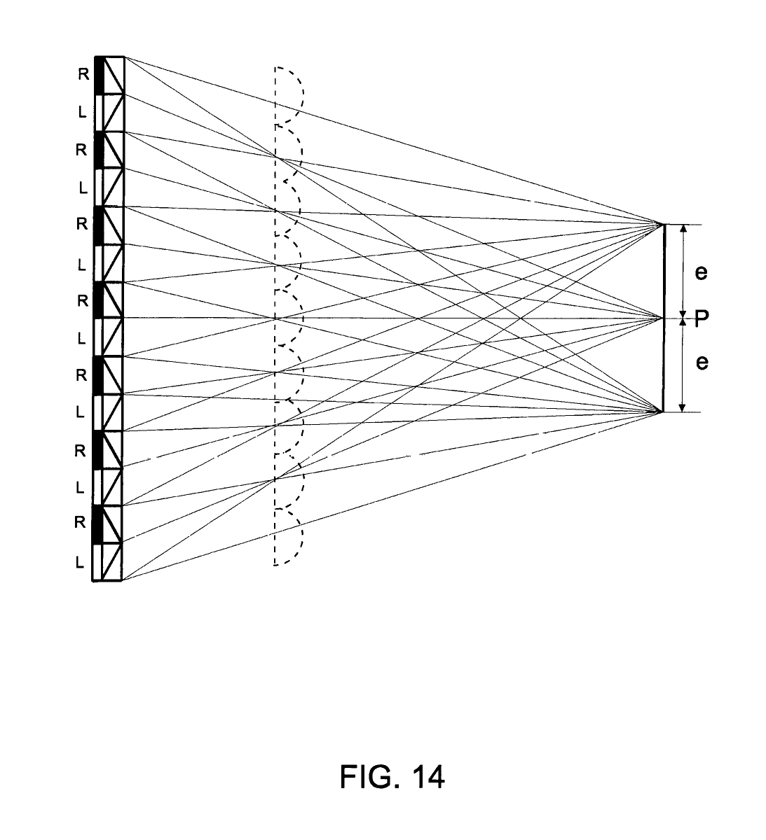

This is illustrated by way of example in FIG. 13, which is a schematic representation of the paths of boundary light rays in a one-view zone of the prismatic flat raster as shown in FIG. 12a. In FIG. 13 one flat prismatic element L, R conditionally indicates the set of some microprisms which equally deflect the light of one pixel towards one of the observer's eyes e. The dashed lines indicate the total internal reflection limit rays making the path of rays up to a nearly perfect analogy of a one-view zone in an equivalent lenticular raster. The notional position of such an equivalent lenticular raster is shown in phantom lines in FIG. 14.

The above-described path of rays may be expected to produce some problems associated with the occurrence of crosstalk, the level of which may depend on the position of an observer's or viewer's eyes with respect to an axis passing through the centre of a stereo image and being parallel to the longitudinal axis of the raster. In the event that the linear dimensions of the stereo images are less than the viewer's interocular distance, the viewer may see a stereo image of high quality substantially without crosstalk, provided that both eyes of the viewer are symmetrical with respect to the specified axis. This is due to the fact that in this case the light from right R-pixels will reach only the right eye and the light from left L-pixels will reach only the left eye of the viewer. However, for example, when the viewer moves his head towards his left shoulder so that the right eye crosses the left edge of the stereo image, then the light from L-pixels being between the right eye and the left edge of the stereo image may reach the right eye. This may cause a crosstalk for the right eye, although zero crosstalk for the left eye may not change as the light from L-pixels may still reach only the left eye. The maximum crosstalk for the right eye may be 100% when the right eye crosses the right edge of the stcreo image, and this means that instead of a volumetric 3D image the viewer may see its transformation to a flat 2D image in this instance.

In the event that the linear dimensions of the stereo images increase towards the viewer's interocular distance and thus the viewer's eyes become within the boundaries of the stereo images, then each eye may have its own crosstalk depending on the viewer's eyes' positions with respect to the axis passing through the centre of the stereo image. Zero crosstalk may be achieved for the eye which will cross its respective edge of the stereo image, and 100% crosstalk may occur for the eye which will be in closest proximity to the other's respective edge.

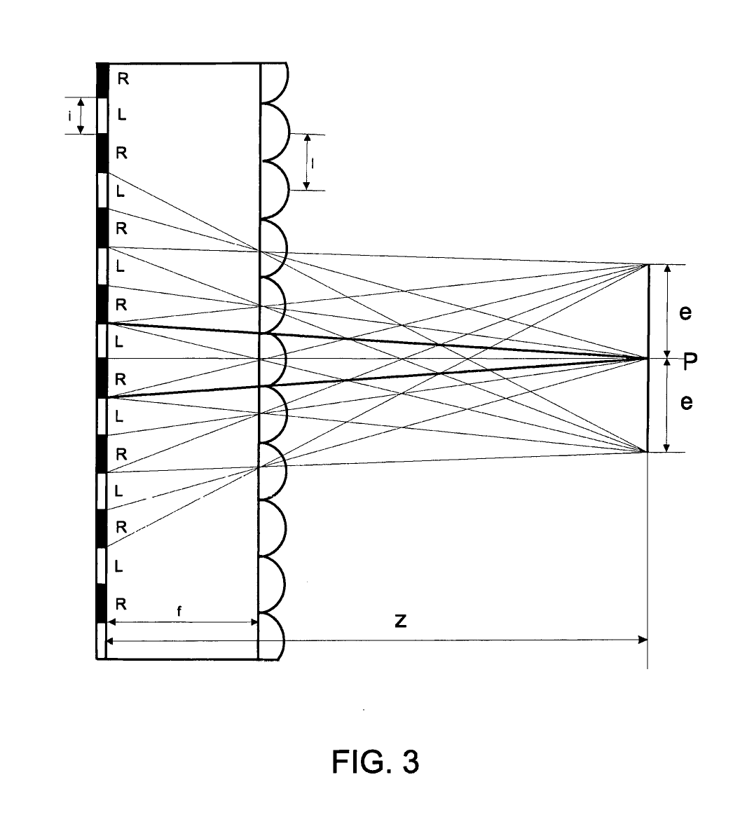

To eliminate, or at least ameliorate, this crosstalk problem it is preferable in embodiments of the present invention to form a comprehensive stereo image surveillance zone as is the case with using a lenticular raster, as illustrated in FIG. 3. This may be achieved by (i) in the case of a prismatic raster based on isosceles triangular prism elements, by changing the size of the base angles of the isosceles triangle so that they are no longer substantially equal to the critical angle of total reflection at the exit plane of the raster body, or (ii) in the case of a Fresnel-type microprismatic raster based on right triangular microprismatic elements, by changing the size of the non-right angle base angle of the right triangle of each microprismatic element so that they are no longer substantially equal to the critical angle of total reflection at the exit plane of the raster body.

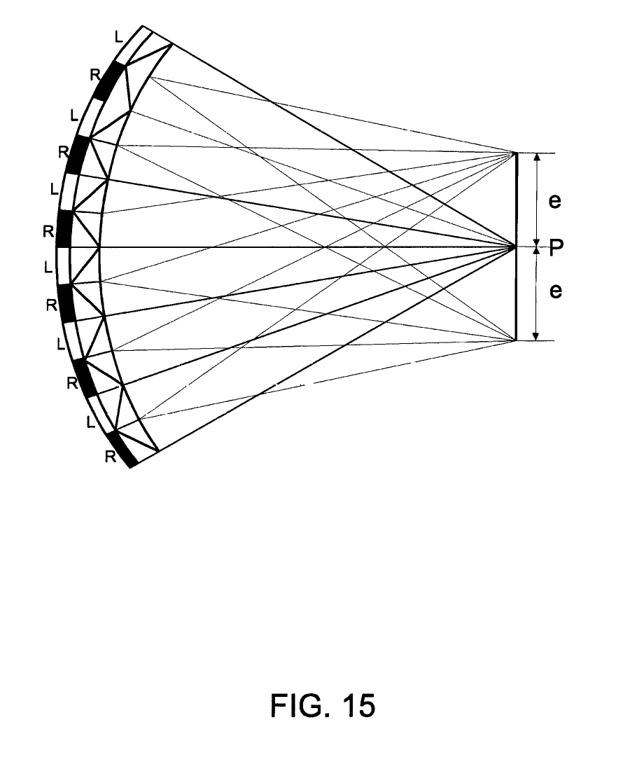

In other words, in the case where the base angle(s) of the isosceles or right (as the case may be) triangles are substantially equal to the critical angle of total reflection at the exit plane of the raster body, this arrangement is representative of the symmetric structure of such rasters (according to the first, second, third and fourth embodiments of the first aspect). Now, in typical embodiments where the base angle(s) of the isosceles or right (as the case may be) triangles are made to be substantially non-equal to the critical angle of total reflection at the exit plane of the raster body, this is representative of the case when the raster plane is relatively large and correction of angles over the whole plane is provided. It might be regarded as a variant to the example shown in FIG. 15 (curved or bent raster): Imagine that the curved raster is projected to the vertical plane, where the triangles have the same orientation as on the curved surface (with respect to the viewer, but not with respect to the plane): when they are positioned on the plane, their angles are constantly slightly changed.

Put another way, sloping TIR borders expand the zone of the stereo imaging and reduce crosstalk. To produce a raster with a sloping TIR boundary can be done either by changing the angle at the base of the micro-prism from the exact equality of the TIR angle, or by bending the plane of the raster; in that case the angle at the base exactly equals the TIR angle.

Put still another way: The meaning of the above features (i) and (ii) is that the change in the angle(s) at the bases of the triangles leads to a change in the propagation direction of the extreme (or outer) TIR (total internal reflection) rays—in the present context this may be termed the “TIR border”. Those angles are denoted ε₀ (the critical TIR angle) until the equality of the angle changes; after that the base of the triangles is denoted simply ε. If the angles c at the bases of the triangles are not equal to the critical TIR angle ε₀, then the TIR limits deviate from the perpendicular to the plane of the raster:
if ε<ε₀, then the TIR limits are deflected towards the left eye of the observer;
if ε>ε₀, then the TIR limits are deflected towards the right eye of the observer.

Thus, the above principle describes one new type of a prismatic raster in accordance with invention, namely those with inclined extreme/outer/marginal rays—i.e. inclined TIR boundary limits. These rasters have an increased visible zone of stereo vision and they also reduce crosstalk.

In this manner, therefore, a nearly perfect analogy between the surveillance zones of a prismatic or microprismatic raster according to the invention and a lenticular raster may be formed.

The same result may be obtained by changing from a flat raster form to a dished plate raster form, as illustrated in FIG. 15. Such a dished plate preferably has a radius which may preferably be dictated by the consumer product or purpose for which the raster is intended to be used. The dished plate raster form may be fabricated by adhering a suitable flat raster to a surface with the required curvature (e.g. cylindrical or otherwise concave), such as a surface of an appropriately curved solid carrier material, plate or other body. Such a flat raster may preferably be a flat raster according to any one of the aforementioned first to fourth embodiments of the first aspect of the invention.

If the occurrence of crosstalk is at a maximum, then a 3D→2D image conversion may occur, enabling the raster to be used in advertising and display technologies.

Various procedures may generally be employed for the production of rasters according to the various embodiments of the invention and for the production and application of stereo images using them.

For example, in some embodiments a method for manufacturing a mono-layer prismatic or microprismatic raster according to the invention may comprise:
(i) producing a profile, preferably a sculptured profile, of a predetermined form, depth and period on a flat surface of an original matrix set;
(ii) making a metal master matrix, preferably using a galvanic process; and
(iii) multiplying the prismatic raster a desired number of times by moulding material(s) with the required refractive index (or indices) of the respective layer(s), e.g. using UV and cold-setting varnish(es) or adhesive(s) with the required refractive index(ices).

In the above-defined manufacturing method the multiplication step (iii) may, instead of employing the defined moulding technique, alternatively comprise:
(iii) multiplying the prismatic raster the desired number of times by stamping out polymer film(s) with the required refractive index(ices), optionally including films not completely covered with a polymer UV layer of a hardening varnish or glue.

As another example, in other embodiments a method for manufacturing a dual-layer prismatic or microprismatic raster according to the invention may comprise:
(i) producing a mono-layer prismatic or microprismatic raster according to any embodiment or example of the above-defined manufacturing method for a mono-layer raster; and
(ii) applying or affixing to said raster produced in (i) one or more additional layers of material of a predetermined suitable thickness, such that the material of the raster body and the additional layer(s) have the respective required refractive indices.

Thus, such manufacturing processes for producing dual-layer prismatic or microprismatic rasters according to the invention, as exemplified by the third and fourth embodiments of the first aspect of the invention defined hereinabove, may differ from the manufacturing processes for mono-layer rasters of the invention, as exemplified by the first and second embodiments of the first aspect defined hereinabove, by the creation of an additional exit layer, such as an additional exit layer of polymeric material, and the following laying of an incoming polymeric layer by means of any suitable known method.

In some embodiments of combinations of a prismatic raster according to the invention together with the said array of a plurality of interlaced stripes of left- and right-images of a stereo pair of images which is to be viewable as the said stereoscopic image, in which the said array is attached or applied to the second side (i.e. the input side) of the raster body, the said array may be printed directly onto the second, input side of the raster. Thus, preferably multiple interlaced images formed by any suitable known printing technique of printing pixels or holographic pixels may be placed on the incoming rasters planes. In this way a ready-to-use stereo product may be created and may for example be used as a souvenir or personalised 3D product, or e.g. in or on packaging of various consumer products having visually distinctive 3D image(s) applied thereto.

In other embodiments of the above-defined combinations, the said array may be carried on a carrier which is attached to the second, input side of the raster body, and which carrier has printed thereon the said array of a plurality of interlaced stripes of left- and right-images of a stereo pair of images which is to be viewable as the said stereoscopic image. Thus, traditional stereo images, interlaced images of which are printed on various types of backing sheets, may be combined with the raster and get stuck to it. It should be noted, in relation to the above possibilities for directly printed and/or backing sheet- or carrier-applied arrays, that stereo images are often currently manufactured under conditions of continuous industrial production of stereo products.

In other embodiments of the above-defined combinations, the raster and the interlaced stripes of left- and right-images of the stereo pair of images may have a macroscopic period frequency dimension which is preferably up to ˜1 lpi. Thus, based on a small typical raster thickness, as in the case of exemplary rasters according the first, second, third and fourth embodiments of the first aspect, offers another type of prismatic raster which is distinguished by a larger, macroscopic order of dimensions of a halftone period with a frequency of, for example, 1 lpi and even less.

In practical implementation of embodiments of the invention an issue that may, and often will, need to be addressed is the problem characteristic of many known manufacturing techniques for stereo images, which is that of achieving perfect alignment of raster element axes (for example corresponding to the axes of lenticular raster cylindrical lenses in such a prior art lenticular system) with the alignment direction of the interlaced image bands. Their imperfect alignment may cause the occurrence of moire fringes throughout the stereo image. In preferred techniques for implementation of embodiments of the invention therefore, the required alignment accuracy may be achieved preferably by scrolling and rotating screens with respect to interlaced image bands to the point of the moire fringes' disappearance and thus the substantial elimination of pseudoscopic stereo images. This is new in the context of the present invention. Relevant here is the fact that the period T of the interlaced images (that is also the period of the raster) can be very broad (e.g. ˜2-4 cm) and still it can provide satisfactory stereo imaging. It is generally impossible to achieve this with a thin (even 0.254 microns) lenticular screen.

If the number of interlaced image bands is decreased, for example to two or four broad bands and the appropriate optical screen structure is used, then strict requirements for a proper alignment of the proposed raster and such an interlaced image may be excluded almost completely, within reason.

As noted above, the proposed interlaced image can be called a “macro-interlaced” image, provided that for example two broad bands serve to generate a stereo pair. Macro-interlaced image dimensions may be determined by a user's requirements and may be equal to that of the required stereo image, for example, a few centimeters.

It should also be noted that due to small values of the proposed raster frequency—about 1 lpi—it may become possible to manufacture a stereo image made up of a large number of stereo angles. Indeed, as is known from [1], the number of stereo image angles N is defined as the ratio:

N=V_{dpi}/Vₗₚᵢ (11)

where V_{dpi} is the frequency (ruling) of the printing device, and
Vₗₚᵢ is the frequency (ruling) of the optical raster.

As noted above, a printed pixel size of about 50 μm with a ruling V_{dpi} of about 500 dpi results in N=500 angles, with one pixel for one angle. However, it may be preferred to print 50 angles with 10 pixels for each of them. As a result one may get multi-angle stereo images of a very high quality which may be used in stereophotography and even in stereomorphing. If one uses a raster according to the present invention in which boundary limit light rays of total internal reflection from (i) each of the two sides of each prism element (in the case of a mono- or dual-layer prismatic raster) or (ii) the hypotenuse of each prism element (in the case of a mono- or dual-layer microprismatic raster, as the case may be, are substantially non-parallel to one another and directed substantially in a direction non-perpendicular to the planar face of the first side of the body of the raster—i.e. with obliquely inclined total internal reflection boundary limit rays—as well, then nearly or virtually zero crosstalk may be achieved.

In embodiments of combinations of a prismatic raster according to the invention together with a backing layer attached to the second side of the raster body, the backing layer may comprise or carry a self-adhesive glue with notched or un-notched (i.e. slotted or unslotted) anti-adhesive material, preferably comprising a silicone coating, or a heat-settable or thermally-activated adhesive, and may be placed on the incoming plane of the raster for subsequent attaching to interlaced images printed on a backing sheet by a user of a 3D production technique, in particular in embodiments in which the said array is printed directly onto the second, input side of the raster.

Furthermore, self-adhesive glue with slotted or unslotted (i.e. notched or un-notched) anti-adhesive material, preferably comprising a silicone coating, or thermally-activated glue, may be placed on top of printed interlaced images, in particular in embodiments of combinations as defined in the preceding paragraph, whereby such a stereo product can be glued to any surface for further applications.

Then, if it is desired to place self-adhesive glue with slotted or unslotted (i.e. notched or un-notched) anti-adhesive material, preferably comprising a silicone coating, or thermally-activated glue on the lower surface of a thus-obtained stereo product, again in particular in embodiments of combinations as defined in the preceding-but-one paragraph, it may be possible to attach this product to any additional surface, for example, without loss of generality, such as that of a book or on a photobook cover, or inside either of them.

As already mentioned hereinabove, the presence of a second total internal reflection at the interface between the prism base and air may lead to extra intensity losses of light outgoing through the prism base. These losses may be decreased if the outgoing plane of the prismatic raster is covered with a further polymeric layer which preferably has a refractive index n which is less than the refractive index nₒ of the prism material, or in the case of a two-layer raster is less than the refractive index nₒ of the material of the outgoing raster layer. This is in accordance with embodiment rasters or combinations wherein an additional layer of optical material is applied onto the first, output side of the raster body, and the additional layer has a refractive index n which is less than the refractive index of the material of the raster body (in the case of a mono-layer raster), or in the case of a dual-layer raster is less than the refractive index of the material of the first (output) raster layer.

By use of this arrangement, according to the relevant calculations this may allow one to obtain an increase in the light intensity by up to ˜25% as compared with arrangements without such an additional polymer layer, because of the resulting increase in the total internal reflection angle at the interface between the prism base and the additional polymeric layer.

In other words, in the case of embodiments of combinations of a prismatic raster according to the invention together with a backing layer attached to the second side of the raster body, or embodiments of combinations of a prismatic raster according to the invention together with the said array of a plurality of interlaced stripes of left- and right-images of a stereo pair of images which is to be viewable as the said stereoscopic image, in which the said array is attached or applied to the second side (i.e. the input side) of the raster body—in either case as defined in the preceding few paragraphs—the interlaced images may be printed on the lower input plane of the raster and then the adhesive may be applied to these printed images (either self-adhesive or heat-activated) and finally this may be glued or stuck to the object in question.

On the other hand, in the case of embodiments of (i) combinations of a prismatic raster according to the invention together with a backing layer attached to the second side of the raster body, or (ii) embodiments of combinations of a prismatic raster according to the invention together with the said array of a plurality of interlaced stripes of left- and right-images of a stereo pair of images which is to be viewable as the said stereoscopic image, in which the said array is carried on a carrier which is attached to the second, input side of the raster body and having printed thereon the said array—in either case as defined in the preceding few paragraphs—the interlaced image may be printed e.g. on paper which is fixed to the bottom (i.e. input) plane of the raster. Then the glue may be applied to the bottom surface of the paper such that this permits subsequent application to the object. The feature of a backing layer being attached to the second side of the raster body may thus be commonly used in print production, where a clean (i.e. not yet used) raster comes in a roll and the raster is combined (=glued together) with the paper on which the interlaced images are printed.

Recently, the increasing availability of 3D photo and video equipment in the consumer market has led to a sustained interest towards the possibility of stereo printing in a domestic setting by consumers. This explains an increased interest in 3D printer development in the industry. However, the characteristic large thicknesses of known lenticular rasters present an aesthetic obstacle in satisfying consumer interest.

Among a large number of patents on 3D printers, patent EP1689592A [25] and reference [9] deserve special attention, as they describe methods and devices which may be most closely aligned with current consumer interest. Here there is proposed the application in real time of framing darts to sheet-like lenticular rasters being fed into a printer, which should be linked to the cylindrical lenses long axis and then read by an optical sensor. The software developed by the authors can correct the orientation of interlaced images to be printed in relation to the raster cylindrical lenses, producing a high print quality of autostereoscopic images.

Thus, and in accordance with further preferred embodiments of the present invention, in order to reduce the thickness of an autostereoscopic image and to simplify the printer design, rasters according to any embodiment(s) of the invention may further comprise one or more, or one or more sets of, framing darts, e.g. arranged perpendicular to the long sides of raster prismatic elements, the darts preferably being marked outside the area of a future stereo image when the raster is being produced. The framing darts may be formed at the master-matrix production stage as matte or holographic lines and may be especially precise.

In the context of an autostereoscopic image printing apparatus including a prismatic raster or a combination in accordance with the invention, or such an apparatus further including a built-in digital camera and software, by using prismatic rasters with framing darts as defined above, instead of lenticular rasters, and by printing interlaced images on the raster input plane, an intermediate product may be obtained. This may constitute yet another aspect of the present invention. A consumer may use this intermediate product, and e.g. apply adhesive thereto on or as a backing layer attached to the second side of the raster body, cut out the image of the required format with a cutting tool, and adhere it on or in a required location, as the consumer selects or wishes.

In certain embodiments of one or more rasters or combinations according to the invention, there may additionally be provided reference lines corresponding to the above-mentioned framing darts, and interlaced images printed using embodiment apparatuses as mentioned in the preceding paragraph. This feature reflects capabilities of using stereo images which can be almost entirely home-made on the basis of embodiment rasters comprising framing darts as discussed above, as well as those printed using embodiment apparatuses as discussed above, especially those including a built-in digital camera and software,

By way of summary: any of the above-defined and above-described preferred embodiments of the present invention may enable the realisation independently of at least one or more of, preferably at least several of, the following advantages, noting of course that not all embodiments may necessarily lead to the same advantage(s) as other embodiments:

1. An extremely low overall thickness of (micro)prismatic rasters down to approximately 5-10 μm for example, which allows autostereoscopic images based on microprismatic rasters to compare favourably with images on holographic labels.

2. The decisive advantage of autostereoscopic images over holographic ones in terms of their natural colour and independence from the light source and the location of stereo images with respect to each other.

3. Common production processes of microprismatic rasters and holographic labels, which allow for the use in the present invention of corresponding well-known technologies associated with the production of holograms.

4. Another advantage of a commercial nature is that in hologram production a new master-matrix is required for each new image, whereas in the present invention it is sufficient to produce just a few master-matrices with a spatial frequency in the range of approximately 100 lpi for stereo image production, while producing individual parts of the image by printing production.

5. The parallelism of total internal reflection limit rays when they propagate along the normal to the raster plane creates a greater depth of the first right and left windows of the stereo image, creating an ability to move an observer along the normal to the raster plane. p 6. In the case of two-layer prismatic and Fresnel-type microprismatic rasters according to the invention which are located between two flat surfaces, this allows for protection of the raster profile from dust and unauthorized copying.

7. Availability of flat external raster surfaces allows printing interlaced images on the raster bottom plane, and applying any printed or holographic image to the top of the raster.

It is to be understood that the above detailed description of preferred embodiments and features of the invention in its various aspects has been by way of non-limiting example(s) only, and various modifications may be made from what has been specifically described and illustrated whilst remaining within the scope of the invention as claimed.

Throughout the description and claims of this specification, the words “comprise” and “contain” and variations of those words, for example “comprising” and “comprises”, mean “including but not limited to”, and are not intended to (and do not) exclude other moieties, additives, components, integers or steps, unless the context otherwise requires.

Throughout the description and claims of this specification, the singular encompasses the plural, unless the context otherwise requires. In particular, where the indefinite article is used, the specification is to be understood as contemplating plurality as well as singularity, unless the context otherwise requires.

Features, integers, characteristics, compounds, chemical moieties or groups described herein in conjunction with a particular aspect, embodiment or example of the invention are to be understood to be applicable to any other aspect, embodiment or example described herein unless incompatible therewith, whilst remaining within the scope of the invention as defined in the appended claims.

### BIBLIOGRAPHY OF CITED REFERENCES

1. Engineering Optics, Springer Series in Optical Sciences, Volume 35, 2008, pp 459-495.

2. http://en.wikicedia.org/wiki/Stereoscopy#Stereoscope and stereographic cards.

3. U.S. Pat. No. 6,275,254—August 2001—Beeteson et al.

4. Neil R. Smith, Don C. Abeysinghe, Joseph W. Haus, and Jason Heikenfeld, “Agile wide-angle beam steering with electrowetting microprisms”, 10 Jul. 2006 No 1.14, No. 14/OPTICS EXPRES, 6557-6563.

5. U.S. Pat. No. 7,688,509—March 2010—Vissenberg et al.

6. U.S. Pat. No. 75,567—Aprril 1903—F.E. Ives.

7. Nail A. Dogson, <<Autostereoscopic 3D Display>>, Published by the IEEE Computer Society, August 2005.

8. Dr. Nick Holliman, <<3D Display Systems>>, University of Durham, Science Laboratories, Feb. 2, 2005.

9. Jonathan Harrold, Graham J. Woodgate, <<Autostereoscopic display technology for mobil 3DTV applications>>, Proc. SPIE Vol. 6490A-19, 2007.G.

10. G. Lippmann, <<Epreuves Reversibles Donnat la Sensation du Relief D, Journal of Phis., Vol. 7, No. 4, 1908.

11. U.S. Pat. No. 4,892,336—January 1990—Wittich Kaul et al.

12. P. P. Sokolov, <<Autostereoscopy and Integral Photography by pr. Lippmann's Method>>, 1911, http://www.futurepicture.org/pdf.

13. Wallen Mphepo, Yi-Pai Huang and Han-Ping D.Shien, <<41.3:Zero Barrier, Zero Crosstalk Autostereoscopic 3D Display System for Cinema & Home Theater Multy-user Settings>>, SID 09 Digest, 615-618.

14. Wallen Mphepo, Yi-Pai Huang, Per Rudquist, and Han-Ping D.Shien, <<An Autostereoscopic 3D Display System Based on Prism Patterned Projection Screen>>, Journal of Display Technology, Vol. 6, No. 3, March 2010, 94-97.

15. U.S. Pat. No. 5,258,833—November 1993—Alan G. Schenk.

16. U.S. Pat. No. 5,774,262—June 1998—Armin Schwerdtner et al.

17. U.S. Pat. No. 6,791,570—September 2004—Armin Schwerdtner et al.

18. U.S. Pat. No. 6,659,615—December 2003—Seiji Umemoto.

19. U.S. Pat. No. 6,846,089—January 2005—James A.Stevenson et al.

20. US 2005/0213001—September 2009—Shun Ueki et al.

21. M. Born, E. Wolf, <<Principles of Optics>>, Pergamon Press, 1968.

22. Newport Corporation http://www.gratings.newport.com.

23. U.S. Pat. No. 7,114,750—October 2006—Alfred V.Alasia et al.

24. WO 2005/035248—April 2005—Bar Yona Itzchak.

25. EP 1 689 592—August 2006—Bar Yona ltzchak.

1. An autostereoscopic prismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a raster period of the raster, the raster comprising:
(i) a body of optically isotropic material having a first side comprising a substantially planar face through which the stereoscopic image is viewable by an observer, and a second side comprising an array of a plurality of relief optical elements adjacent one another;
(ii) each said relief optical element having a relief surface and a polygonal cross-section comprising at least one triangular cross-section with left and right side portions and a base with a length corresponding to said raster period;
wherein, for creating and viewing said stereoscopic image, the relief optical elements of the raster body are configured, and are arrangeable relative to the left- and right-image stripes of the interlaced array, such that:
(iii) on each of the left and right side portions of the relief optical elements:
within a respective predefined range of incident angles on the respective relief optical element side portion light rays from corresponding ones of the respective left- and right-image stripes undergo refraction at the relief surface thereof and at the substantially planar face of the raster body so as to exit the raster body via the substantially planar face thereof, and
outside the said respective predefined range of incident angles on the respective relief optical element side portion light rays from corresponding ones of the respective left- and right-image stripes undergo refraction at the relief surface thereof and total internal reflection at the substantially planar face of the raster body, so as to substantially not exit the raster body via the substantially planar face thereof,
whereby the angular limits of the said respective predefined range of incident angles on the respective relief optical element side portion constitute boundary incident angular limits beyond which the light rays from corresponding ones of the respective left- and right-image stripes substantially cannot exit the raster body via the substantially planar face thereof;
and such that:
(iv) the respective said boundary incident angular limits on each respective one of the left and right side portions of each respective relief optical element, beyond which the light rays from corresponding ones of the respective left- and right-image stripes substantially cannot exit the raster body via the substantially planar face thereof, are such that the left parts of the stereoscopic image from the left-image stripes which pass through the left side portions of the relief optical elements within each raster period and exit the raster body via the substantially planar face thereof are directed substantially towards the observer's left eye, and the right parts of the stereoscopic image from the right-image stripes which pass through the right side portions of the relief optical elements within each raster period and exit the raster body via the substantially planar face thereof are directed substantially towards the observer's right eye.

2. A prismatic raster according to claim 1, wherein each said relief optical element has a cross-section selected from an isosceles triangle and a right triangle.

3. A prismatic raster according to claim 1, wherein individual relief optical elements forming the array in the second side of the raster body are configured adjacent one another and contacting one another substantially without gaps in between adjacent relief optical elements.

4. A prismatic raster according to claim 1, wherein the optically isotropic material forming the body of the raster has a refractive index no and, for creating and viewing the said stereoscopic image, the first and second sides of the raster body are in contact with a medium with a refractive index lower than no.

5. A prismatic raster according to claim 1, which is a mono-layer prismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period of the raster, the prismatic raster comprising:
(i) a body of optically isotropic material having a first side comprising a substantially planar face through which the stereoscopic image is viewable by an observer, and a second side comprising an array of a plurality of prism elements adjacent one another and preferably substantially without gaps in between adjacent prism elements;
(ii) each said prism element having a relief surface and a cross-section in the form of an isosceles triangle with left and right sides and a base having a length corresponding to said prismatic raster period;
wherein, for creating and viewing said stereoscopic image, the prism elements of the raster body are configured, and are arrangeable relative to the left- and right-image stripes of the interlaced array, such that:
(iii) on each of the left and right sides of the prism elements:
within a respective predefined range of incident angles on the respective prism element side light rays from corresponding ones of the respective left- and right-image stripes undergo refraction at the relief surface thereof and at the substantially planar face of the raster body so as to exit the raster body via the substantially planar face thereof, and
outside the said respective predefined range of incident angles on the respective prism element side light rays from corresponding ones of the respective left- and right-image stripes undergo refraction at the relief surface thereof and total internal reflection at the substantially planar face of the raster body, so as to substantially not exit the raster body via the substantially planar face thereof,
whereby the angular limits of the said respective predefined range of incident angles on the respective prism element side constitute boundary incident angular limits beyond which the light rays from corresponding ones of the respective left- and right-image stripes substantially cannot exit the raster body via the substantially planar face thereof;
and such that:
(iv) the respective said boundary incident angular limits on each respective one of the left and right sides of each respective prism element, beyond which the light rays from corresponding ones of the respective left- and right-image stripes substantially cannot exit the raster body via the substantially planar face thereof, are such that the left parts of the stereoscopic image from the left-image stripes which pass through the left sides of the prism elements within each raster period and exit the raster body via the substantially planar face thereof are directed substantially towards the observer's left eye, and the right parts of the stereoscopic image from the right-image stripes which pass through the right sides of the prism elements within each raster period and exit the raster body via the substantially planar face thereof are directed substantially towards the observer's right eye.

6. A prismatic raster according to claim 1, which is a mono-layer microprismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period of the raster, the microprismatic raster comprising:
(i) a body of optically isotropic material having a first side comprising a substantially planar face through which the stereoscopic image is viewable by an observer, and a second side comprising an array of a plurality of identical microprism elements adjacent one another and preferably substantially without gaps in between adjacent microprism elements, each said microprism element having left and right portions;
(ii) each of said left portions of each microprism element having a cross-section in the form of an array of left-directional Fresnel microprisms and each of said right portions of each microprism element having a cross-section in the form of an array of right-directional Fresnel microprisms, each said Fresnel microprism having a relief surface and a cross-section in the form of a right triangle,
wherein in a left half of each prismatic period the Fresnel microprisms each have a left-directed hypotenuse and a first base, and in a right half of each prismatic raster period the Fresnel microprisms each have a right-directed hypotenuse and a second base, the said first and second bases of the Fresnel microprisms being parallel to a base of the respective microprism element, and within each prismatic raster period a sum of the lengths of the first and second bases of the left-directional and the right-directional Fresnel microprisms corresponds to said prismatic raster period;
wherein, for creating and viewing said stereoscopic image, the microprism elements of the raster body are configured, and are arrangeable relative to the left- and right-image stripes of the interlaced array, such that:
(iii) on each of the left-directed and right-directed hypotenuses of the respective left-directional and right-directional Fresnel microprisms of each microprism element:
within a respective predefined range of incident angles on the respective Fresnel microprism hypotenuse light rays from corresponding ones of the respective left- and right-image stripes undergo refraction at the relief surface thereof and at the substantially planar face of the raster body so as to exit the raster body via the substantially planar face thereof, and
outside the said respective predefined range of incident angles on the respective Fresnel microprism hypotenuse light rays from corresponding ones of the respective left- and right-image stripes undergo refraction at the relief surface thereof and total internal reflection at the substantially planar face of the raster body, so as to substantially not exit the raster body via the substantially planar face thereof,
whereby the angular limits of the said respective predefined range of incident angles on the respective Fresnel microprism hypotenuse constitute boundary incident angular limits beyond which the light rays from corresponding ones of the respective left- and right-image stripes substantially cannot exit the raster body via the substantially planar face thereof;
and such that:
(iv) the respective said boundary incident angular limits on each respective one of the left-directed and right-directed hypotenuses of the respective Fresnel microprisms of each microprism element, beyond which the light rays from corresponding ones of the respective left- and right-image stripes substantially cannot exit the raster body via the substantially planar face thereof, are such that the left parts of the stereoscopic image from the left-image stripes which pass through the left-directed hypotenuses of the left-directional Fresnel microprisms within the left half of each prismatic raster period and exit the raster body via the substantially planar face thereof are directed substantially towards the observer's left eye, and the right parts of the stereoscopic image from the right-image stripes which pass through the right-directed hypotenuses of the right-directional Fresnel microprisms within the right half of each prismatic raster period and exit the raster body via the substantially planar face thereof are directed substantially towards the observer's right eye.

7. A prismatic raster according to claim 1, which is a dual-layer prismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period of the raster, the prismatic raster comprising:
(i) a body comprising a first layer of optically isotropic material with refractive index no, and a second layer of optically isotropic material with refractive index ni, with the proviso that no>n i,
wherein the first and second layers each include an outer side and an inner side, the outer side of the first layer comprising a substantially planar face through which the stereoscopic image is viewable by an observer,
and wherein the inner sides of the first and second layers each comprise an array of a plurality of prism elements adjacent one another and preferably substantially without gaps in between adjacent prism elements, the array of prism elements on the inner side of the first layer contacting the array of prism elements on the inner side of the second layer;
(ii) each said prism element on the inner side of each of the first and second layers having a relief surface and a cross-section in the form of an isosceles triangle having a base and adjacent left and right sides, the length of said base of each isosceles triangle corresponding to said prismatic raster period,
wherein an isosceles triangular prism element of one of the first or second layers together with a complementary pair of contacting isosceles triangular prism elements of the other of the first or second layers located to either side of the said first-mentioned isosceles triangular prism element constitute a prismatic unit having a cross-section in the form of a rectangle, the length of said rectangle corresponding to said prismatic raster period;
wherein, for creating and viewing said stereoscopic image, the prism elements of the raster body are configured, and are arrangeable relative to the left- and right-image stripes of the interlaced array, such that:
(iii) on each of the left and right sides of the prism elements in the first layer:
within a respective predefined range of incident angles on the respective prism element side light rays from corresponding ones of the respective left- and right-image stripes undergo refraction at the relief surface thereof and at the substantially planar face of the raster body so as to exit the raster body via the substantially planar face thereof, and
outside the said respective predefined range of incident angles on the respective prism element side light rays from corresponding ones of the respective left- and right-image stripes undergo refraction at the relief surface thereof and total internal reflection at the substantially planar face of the raster body, so as to substantially not exit the raster body via the substantially planar face thereof,
whereby the angular limits of the said respective predefined range of incident angles on the respective prism element side constitute boundary incident angular limits beyond which the light rays from corresponding ones of the respective left- and right-image stripes substantially cannot exit the raster body via the substantially planar face thereof;
and such that:
(iv) the respective said boundary incident angular limits on each respective one of the left and right sides of each respective prism element in the first layer, beyond which the light rays from corresponding ones of the respective left- and right-image stripes substantially cannot exit the raster body via the substantially planar face thereof, are such that the left parts of the stereoscopic image from the left-image stripes which pass through the left sides of the prism elements in the first layer within each raster period and exit the raster body via the substantially planar face thereof are directed substantially towards the observer's left eye, and the right parts of the stereoscopic image from the right-image stripes which pass through the right sides of the prism elements in the first layer within each raster period and exit the raster body via the substantially planar face thereof are directed substantially towards the observer's right eye.

8. A prismatic raster according to claim 1, which is a dual-layer microprismatic raster for the creation of a stereoscopic image from an array of interlaced stripes of left- and right-images of a stereo pair, wherein the distance between adjacent stripes within each interlaced stereo image defines a stereo image period, said stereo image period being substantially equal to a prismatic raster period of the raster, the microprismatic raster comprising:
(i) a body comprising a first layer of optically isotropic material with refractive index no, and a second layer of optically isotropic material with refractive index ni, with the proviso that no>ni,
wherein the first and second layers each include an outer side and an inner side, the outer side of the first layer comprising a substantially planar face through which the autostereoscopic image is viewable by an observer,
and wherein the inner sides of the first and second layers each comprise an array of a plurality of identical microprism elements adjacent one another and preferably substantially without gaps in between adjacent microprism elements, each said microprism element having left and right portions, the array of microprism elements on the inner side of the first layer contacting the array of microprism elements on the inner side of the second layer;
(ii) each of said left portions of each microprism element having a cross-section in the form of an array of left-directional Fresnel microprisms and each of said right portions of each microprism element having a cross-section in the form of an array of right-directional Fresnel microprisms, each said Fresnel microprism having a relief surface and a cross-section in the form of a right triangle,
wherein in a left half of each prismatic period the Fresnel microprisms each have a left-directed hypotenuse and a first base, and in a right half of each prismatic raster period the Fresnel microprisms each have a right-directed hypotenuse and a second base, the said first and second bases of the Fresnel microprisms being parallel to a base of the respective microprism element, and within each prismatic raster period a sum of the lengths of the first and second bases of the left-directional and the right-directional Fresnel microprisms corresponds to said prismatic raster period,
and wherein a Fresnel microprism of one of the first or second layers together with a complementary pair of contacting Fresnel microprisms of the other of the first or second layers located to either side of the said first-mentioned Fresnel microprism constitute a Fresnel microprismatic unit having a cross-section in the form of a rectangle, a sum of the lengths of said Fresnel microprismatic units corresponding to said prismatic raster period;
wherein, for creating and viewing said stereoscopic image, the microprism elements of the raster body are configured, and are arrangeable relative to the left- and right-image stripes of the interlaced array, such that:
(iii) on each of the left-directed and right-directed hypotenuses of the respective left-directional and right-directional Fresnel microprisms of each microprism element in the first layer:
within a respective predefined range of incident angles on the respective Fresnel microprism hypotenuse light rays from corresponding ones of the respective left- and right-image stripes undergo refraction at the relief surface thereof and at the substantially planar face of the raster body so as to exit the raster body via the substantially planar face thereof, and
outside the said respective predefined range of incident angles on the respective Fresnel microprism hypotenuse light rays from corresponding ones of the respective left- and right-image stripes undergo refraction at the relief surface thereof and total internal reflection at the substantially planar face of the raster body, so as to substantially not exit the raster body via the substantially planar face thereof,
whereby the angular limits of the said respective predefined range of incident angles on the respective Fresnel microprism hypotenuse constitute boundary incident angular limits beyond which the light rays from corresponding ones of the respective left- and right-image stripes substantially cannot exit the raster body via the substantially planar face thereof;
and such that:
(iv) the respective said boundary incident angular limits on each respective one of the left-directed and right-directed hypotenuses of the respective Fresnel microprisms of each microprism element in the first layer, beyond which the light rays from corresponding ones of the respective left- and right-image stripes substantially cannot exit the raster body via the substantially planar face thereof, are such that the left parts of the stereoscopic image from the left-image stripes which pass through the left-directed hypotenuses of the left-directional Fresnel microprisms in the first layer within the left half of each prismatic raster period and exit the raster body via the substantially planar face thereof are directed substantially towards the observer's left eye, and the right parts of the stereoscopic image from the right-image stripes which pass through the right-directed hypotenuses of the right-directional Fresnel microprisms in the first layer within the right half of each prismatic raster period and exit the raster body via the substantially planar face thereof are directed substantially towards the observer's right eye.

9. A prismatic raster according to claim 5, wherein the angles adjacent the base of each isosceles triangle of each prism element are substantially equal to a critical angle of total internal reflection at a boundary between a medium surrounding the raster and the body of the raster.

10. A prismatic raster according to claim 7, wherein the angles adjacent the base of each isosceles triangle of each prism element are substantially equal to a critical angle of total internal reflection at a boundary between the first and second layers of the raster body.

11. A prismatic raster according to claim 5, wherein the angles adjacent the base of each isosceles triangle of each prism element are substantially non-equal to a critical angle of total internal reflection at a boundary between a medium surrounding the raster and the body of the raster.

12. A prismatic raster according to claim 7, wherein the angles adjacent the base of each isosceles triangle of each prism element are substantially non-equal to a critical angle of total internal reflection at a boundary between the first and second layers of the raster body.

13. A prismatic raster according to claim 9, wherein light rays corresponding to one of the said respective boundary incident angular limits on each of the left and right sides of each respective prism element are substantially parallel to one another and directed substantially in a direction perpendicular to the planar face of the first side of the body of the raster.

14. A prismatic raster according to claim 11, wherein light rays corresponding to both of the said respective boundary incident angular limits on each of the left and right sides of each respective prism element are substantially non-parallel to one another and directed substantially in a direction non-perpendicular to the planar face of the first side of the body of the raster.

15. A prismatic raster according to claim 6, wherein a non-right angle adjacent the base of each right triangle of each microprismatic element of each prism element is substantially equal to a critical angle of total internal reflection at a boundary between a medium surrounding the raster and the body of the raster.

16. A prismatic raster according to claim 8, wherein a non-right angle adjacent the base of each right triangle of each microprismatic element of each prism element is substantially equal to a critical angle of total internal reflection at a boundary between the first and second layers of the raster body.

17. A prismatic raster according to claim 6, wherein a non-right angle adjacent the base of each right triangle of each microprismatic element of each prism element is substantially non-equal to a critical angle of total internal reflection at a boundary between a medium surrounding the raster and the body of the raster.

18. A prismatic raster according to claim 8, wherein a non-right angle adjacent the base of each right triangle of each microprismatic element of each prism element is substantially non-equal to a critical angle of total internal reflection at a boundary between the first and second layers of the raster body.

19. A prismatic raster according to claim 15, wherein light rays corresponding to one of the said respective boundary incident angular limits on each hypotenuse of each respective microprismatic element are substantially parallel to one another and directed substantially in a direction perpendicular to the planar face of the first side of the body of the raster.

20. A prismatic raster according to claim 17, wherein light rays corresponding to both of the said respective boundary incident angular limits on each hypotenuse of each microprismatic element are substantially non-parallel to one another and directed substantially in a direction non-perpendicular to the planar face of the first side of the body of the raster.

21. A prismatic raster according to claim 1 which is in the form of a material selected from the group consisting of a sheet and film of polymeric material.

22. A prismatic raster according to claim 1, selected from the group consisted of a mono-layer prismatic raster and a mono-layer microprismatic raster according thereto, further comprising a substantially planar layer, selected from the group consisting of a protective polymer layer and a protective polymer film, at least around a perimeter thereof, to the second side of the raster body.

23. A prismatic raster according to claim 1, further comprising an attachment layer attached to the first side of the raster body.

24. A prismatic raster according to claim 23, wherein the attachment layer comprises an adhesive selected from the group consisting of (a) self-adhesive glue comprising an anti-adhesive material selected from the group consisting of a notched anti-adhesive material; and an un-notched anti-adhesive material, and (b) a heat-settable adhesive material.

25. In combination, a prismatic raster according to claim 1 together with a said array of a plurality of interlaced stripes of left- and right-images of a stereo pair of images which is to be viewable as the said stereoscopic image, the said array being applied to the second side (i.e. the input side) of the raster body by a method selected from the group consisting of (a) attaching the said array to the second side of the raster body, and (b) printing the said array directly onto the second side of the raster body.

26. (canceled)

27. A combination according to claim 25, wherein the said array is carried on a carrier which is attached to the second, input side of the raster body and having printed thereon the said array of a plurality of interlaced stripes of left- and right-images of a stereo pair of images which is to be viewable as the said stereoscopic image.

28. A combination according to claim 25, wherein the raster and the interlaced stripes of left- and right-images of the stereo pair of images have a macroscopic period frequency dimension which is preferably up to ˜1 lpi.

29. In combination, a prismatic raster according to claim 1 together with a backing layer attached to the second side of the raster body wherein the backing layer comprises an adhesive selected from the group consisting of (a) a self-adhesive glue comprising an antihesive material sleeted from the group consisting of a notched antiadhesive material and an un-notched anti-adhesive material, and (b) a heat-settable adhesive.

30. A prismatic raster according to claim 1 affixed to a surface selected from the group consisting of a product or object, wherein said surface is selected from the group consisting of:
(i) a surface which is substantially flat, or
(ii) a surface which is curved.

31. (canceled)

32. (canceled)

33. A prismatic raster according to claim 1, wherein an additional layer of optical material is applied onto the first, output side of the raster body, and the additional layer has a refractive index n which is less than the refractive index of the material of the raster body (in the case of a mono-layer raster), and in the case of a dual-layer raster is less than the refractive index of the material of the first (output) raster layer.

34. A prismatic raster according to claim 1 wherein the first, output raster body side is printed with indicia, information or one or more images.

35. A prismatic raster according to claim 1, wherein the raster further comprises one or more, or one or more sets of, framing darts.

36. A method of manufacturing a raster according to claim 1, which raster is selected from the group consisting of a mono-layer prismatic raster or a mono-layer microprismatic raster according thereto, the method comprising:
(i) producing a profile of a predetermined form, depth and period on a flat surface of an original matrix set;
(ii) making a metal master matrix; and
(iii) multiplying the prismatic raster a desired number of times by moulding material(s) with the required refractive index (indices) of the respective layer(s).

37. A method according to claim 36, which method comprises the steps of:
(i) producing a sculptured profile of a predetermined form, depth and period on the flat surface of the original matrix set;
(ii) making a metal master matrix using a galvanic process; and
(iii) multiplying the prismatic raster the desired number of times selected from the group consisting of: using UV and cold-setting varnish(es) with the required refractive index(ices); using UV and cold-setting adhesive(s) with the required refractive index(ices); and multiplying the prismatic raster the desired number of times by stamping out polymer film(s) with the required refractive index(ices), wherein such films are not completely covered with a polymer UV layer selected from the group consisting of: a hardening varnish or glue.

38. (canceled)

39. A method of manufacturing a raster according to claim 1, which raster is selected from the group consisting of a dual-layer prismatic raster or a dual-layer microprismatic raster according thereto, the method comprising:
(i) producing a the raster according to the method of claim 36; and
(ii) applying said raster produced in (i) one or more additional layers of material of a predetermined suitable thickness, such that the material of the raster body and the additional layer(s) have the respective required refractive indices.

40. An autostereoscopic image printing apparatus including a prismatic raster according to.

41. An apparatus according to claim 40, the apparatus further including a built-in digital camera and software that allows adjustment of long sides of the interlaced images perpendicular to framing darts (where used) of the prismatic raster when preparing to print.

42. One or more prismatic rasters according to claim 1, additionally including reference lines corresponding to framing darts, and interlaced stripes of left- and right-images of a stereo pair printed thereon.

43. (canceled)

44. A prismatic raster according to claim 10, wherein light rays corresponding to one of the said respective boundary incident angular limits on each of the left and right sides of each respective prism element are substantially parallel to one another and directed substantially in a direction perpendicular to the planar face of the first side of the body of the raster.

45. A prismatic raster according to claim 12, wherein light rays corresponding to both of the said respective boundary incident angular limits on each of the left and right sides of each respective prism element are substantially non-parallel to one another and directed substantially in a direction non-perpendicular to the planar face of the first side of the body of the raster.

46. A prismatic raster according to claim 16, wherein light rays corresponding to one of the said respective boundary incident angular limits on each hypotenuse of each respective microprismatic element are substantially parallel to one another and directed substantially in a direction perpendicular to the planar face of the first side of the body of the raster.

47. A prismatic raster according to claim 18, wherein light rays corresponding to both of the said respective boundary incident angular limits on each hypotenuse of each microprismatic element are substantially non-parallel to one another and directed substantially in a direction non-perpendicular to the planar face of the first side of the body of the raster.
